(19) United States
(12) Patent Application Publication
(10) Pub. No.: US 2026/0227300 A1
(43) Pub. Date: Aug. 6, 2026

(54) FUSION SYSTEM AND METHOD OF PERFORMING SAMPLE FUSION THEREWITH

(71) Applicant: SPECTRIS CANADA INC., Quebec (CA)

(72) Inventors: Pierre BOUCHARD, Quebec (CA); Julien BOISCLAIR, Quebec (CA)

(21) Appl. No.: 19/151,465

(22) PCT Filed: Feb. 8, 2024
(86) PCT No.: PCT/CA2024/050161

§ 371 Date: Jul. 28, 2025

Related U.S. Application Data
(60) Provisional application No. 63/483,789, filed on Feb. 8, 2023.
(60) Provisional application No. 63/494,279, filed on Apr. 5, 2023.

(51) Int. Cl. G01N 1/44; F27B 9/30

(52) U.S. Cl. CPC G01N 1/44; F27B 9/30

(57) ABSTRACT

The fusion system can have a furnace having a fusion area, and at least one heating element; and an agitation mechanism having a set of agitation rods, each agitation rod extending upwardly to a terminal end located at the fusion area, the terminal ends operable to support a sample holder, the agitation mechanism being operable to revolve the terminal ends around parallel, upwardly oriented rotation axes, while the at least one heating element is activated.

### TECHNICAL FIELD

The application relates generally to the field of analytical sample preparation, and more particularly, to the field of analytical sample preparation by fusion.

### BACKGROUND

High quality and productive sample preparation can be key for chemical analysis of samples using X-Ray Fluorescence Spectrometry (XRF), Inductively Coupled Plasma Optical Emission Spectroscopy (ICP-OES), Inductively Coupled Plasma Mass Spectrometry (ICP-MS) and Atomic Absorption Spectroscopy (AAS). Whichever samples are being assessed (e.g. loose or pressed powders, glass disks, solid samples, or liquid solutions), finding the right approach to sample preparation is the first, and often the most important step in achieving accurate and reproducible results.

Fusion process sample preparation can involve heating up the chemical compound to melt the sample/flux, and then cooling down the melt to solidify the sample. In a typical fusion system, the mechanism that holds the sample crucible moves the sample from a heating zone to a cooling zone, and holds the sample crucible during the heating. Since process temperatures can be quite high, various problems and challenges can arise, such as contamination of the sample, health & safety concerns for operators, challenges and costs associated to selecting materials operable to sustain high temperatures which can be present at the fusion area, and thermal inertia of components which may interfere with or slow the reaching of an intended thermal state. Moreover, the fusion process can be a bottleneck in a sample analysis process, and therefore, productivity can be a significant additional concern. There always remains room for improvement.

### SUMMARY

It was found that in some embodiments, such challenges could be addressed by a fusion system having an agitation mechanism which is entirely distinct from a handling mechanism, and a handling mechanism which can be used to place the samples onto the agitation mechanism and retrieve the samples from the agitation mechanism. The agitation system can have a plurality of rods which extend upwardly to terminal ends which can support the samples. The agitation system can agitate the samples during heating by revolving the terminal ends around corresponding axes along circular or ellipsoid paths defined in the horizontal orientation. If the fusion area is defined in an enclosed heating chamber, a proximal end of the rods opposite the terminal ends can protrude outside the heating chamber, such as through openings defined across a bottom wall of the heating chamber, and the mechanism which holds the proximal end of the rods and drives their circular or ellipsoid movement can be entirely positioned outside the heating chamber.

In accordance with one aspect, there is provided a method of fusing samples in a furnace, the method comprising: terminal ends of upwardly extending agitation rods supporting a sample holder containing the samples at a fusion area of the furnace; fusing the samples at the fusion area; agitating the sample holder and the samples at the fusion area, including revolving the terminal ends around corresponding upwardly oriented axes.

Some embodiments can further include supporting the agitation rods collectively at a common rod support, and said revolving the terminal ends includes moving the common rod support in a circular or ellipsoid path.

Some embodiments can further include engaging the sample holder with the terminal ends prior to said fusing and agitating, and disengaging said sample holder from said terminal ends subsequently to said fusing and agitating.

In some embodiments, said engaging includes lowering the sample holder onto the terminal ends and said disengaging includes raising the sample holder from the terminal ends.

In some embodiments, said lowering and said raising is performed by lowering and raising a support having a plurality of parallel, horizontally oriented prongs, while the prongs are interspersed with the agitation rods.

Some embodiments can further include said revolving includes positioning the agitation rods in the interspersed configuration with the prongs prior to said engaging and disengaging.

In some embodiments, said revolving the terminal ends includes moving the terminal ends along associated arcuate paths in a first angular orientation.

In some embodiments, said revolving includes, subsequently to said moving the terminal ends along the associated arcuate paths in the first angular orientation, moving the terminal ends along the associated arcuate paths in a second angular orientation.

In some embodiments, said revolving the terminal ends includes moving the terminal ends along a plurality of revolutions around the corresponding upwardly oriented axes.

In accordance with another aspect, there is provided a fusion system comprising: a furnace having a fusion area, and at least one heating element; and an agitation mechanism having a set of agitation rods, each agitation rod extending upwardly to a terminal end located at the fusion area, the terminal ends operable to support a sample holder, the agitation mechanism being operable to revolve the terminal ends around parallel, upwardly oriented rotation axes, while the at least one heating element is activated.

In some embodiments, the agitation mechanism has at least one rotary shaft positioned below the agitation rods, the at least one rotary shaft being rotatable by an actuator, the agitation rods each having a proximal end connected to the at least one rotary shaft, wherein the rotation of the at least one rotary shaft is communicated by the connection and by the agitation rod to cause the revolving of the terminal ends.

In some embodiments, the furnace has a heating chamber enclosing the fusion area, wherein the at least one rotary shaft, the connection, and the proximal ends of the agitation rods are positioned outside the heating chamber, the agitation rods extending into the heating chamber via corresponding apertures formed in a bottom wall of the heating chamber.

In some embodiments, the proximal ends of the agitation rods are secured to a common rod support, the rod support connecting the agitation rods to the at least one rotary shaft.

In some embodiments, the rod support has a planar member covering the apertures formed in the bottom wall.

Some embodiments can further include at least two of said at least one rotary shaft, the at least two rotary shafts being offset from one another, all rotary shafts connecting the common rod support in an eccentric manner.

In some embodiments, the first rotary shaft and the second rotary shaft have corresponding drive wheels, further comprising a loop member driven by the actuator to drive the drive wheels.

Some embodiments can further include a controller operable to control the agitation mechanism.

In some embodiments, the sample holder has sockets mating with the terminal ends, the sample holder being disengageable from the agitation rods by raising the sockets away from the terminal ends.

Many further features and combinations thereof concerning the present improvements will appear to those skilled in the art following a reading of the instant disclosure. In particular, all technical implementation details and advantages described with respect to a particular aspect of the present invention are self-evidently mutatis mutandis applicable for all other aspects of the present invention.

### DESCRIPTION OF THE DRAWINGS

Reference is now made to the accompanying figures in which:

FIG. 1A is a perspective view of a fusion system;

FIG. 1B is a perspective view showing internal components of the fusion system of FIG. 1A;

FIG. 1C is a cross-sectional view of a portion of the fusion system of FIGS. 1A and 1B;

FIG. 1D is another a cross-sectional view of a portion of the fusion system of FIGS. 1A and 1B;

FIG. 1E is an example of a controller of the fusion system of FIGS. 1A and 1B;

FIG. 2A is a perspective view of a sample holder;

FIG. 2B is a perspective view of the sample holder of FIG. 2A with a plurality of containers;

FIG. 2C is a schematic top plan view of terminal ends of agitation or support rods;

FIG. 2D is a schematic top plan view similar to the view of FIG. 2C, showing engagement of an integral sample holder to the terminal ends;

FIG. 2E is a schematic top plan view similar to the view of FIG. 2C, showing engagement of a sample holder having two loosely connected segments to the terminal ends;

FIG. 2F is a partial perspective view, exploded, of another example of a sample holder;

FIG. 2G is a partial perspective view of yet another example of a sample holder;

FIG. 2H is a partial perspective view, sectioned, of the sample holder of FIG. 2F;

FIG. 3A is a perspective view of a handling mechanism of the fusion system of FIGS. 1A and 1B;

FIG. 3B is another view of the handling mechanism of FIG. 3A;

FIG. 3C is yet another view of the handling mechanism of FIG. 3A;

FIG. 3D is yet another view of the handling mechanism of FIG. 3A;

FIG. 3E is a bottom plan view of a linkage of the handling mechanism of FIG. 3A;

FIG. 3E1 is an enlarged view of a portion of FIG. 3E;

FIG. 3F is a top plan view of the linkage of FIG. 3E;

FIG. 3G is yet another view of the handling mechanism of FIG. 3A;

FIG. 3H is yet another view of the handling mechanism of FIG. 3A;

FIG. 4A is a perspective view of an agitation mechanism of the fusion system of FIGS. 1A and 1B;

FIG. 4B is another perspective view of the agitation mechanism of FIG. 4A;

FIG. 4C is a cross-sectional view of the agitation mechanism of FIG. 4A; and

FIG. 4D is an enlarged cross-sectional view of part of FIG. 4C.

### DETAILED DESCRIPTION

A fusion system for the preparation of inorganic analytical samples (or mineral analytical samples) is disclosed. The fusion system includes a furnace operable to receive containers such as crucibles therein for heating the contents of the containers in order to prepare a fused mixture for analysis. An inorganic sample is solubilized in a fused flux to obtain a fused mixture (also referred to as a sample herein, or as a fused sample) suitable to prepare analytical samples. The analytical sample can be a glass disk for X-ray fluorescence (XRF) analysis, a solution for inductively coupled plasma (ICP) analysis or a solution for atomic absorption (AA) analysis, to name some examples.

In one embodiment, the fusion system can include a furnace having heating element(s), and a sample holder operable to support a plurality of containers such as crucibles in which the fused mixture can be generated or such as moulds in which the fused mixture can be solidified. In some embodiments, the furnace has an enclosed heating chamber. In such embodiments, the heating elements can be operated to increase the temperature within the heating chamber, which can be referred to as pre-heating the heating chamber, before introducing the sample holder and the crucibles into the heating chamber. In other embodiments, the heating elements may be operated only when the sample holder and the crucibles are in a heating position. Once fused, different approaches can exist depending on the application. In one embodiment, the sample can stay in the crucible (e.g. mouldable or peroxide application). In another embodiment, the samples can be transferred from the crucibles to other containers prior to cooling, and the analytical samples thereby obtained can be operable to sustain subsequent analysis. Such other containers can be moulds in the case of XRF analysis to obtain glass disks, or beakers containing an acidic solution for ICP and/or AA analysis, to name some examples. In some embodiments, it can be desired for such other containers to be subjected to the same temperature conditions as the samples during the fusion process.

It should be understood that, as used herein, the expressions “fuse”, “fusing”, “fusion”, or any other equivalent expression, refers to the process of dissolving material into flux in order to prepare a homogeneous, or near-homogeneous, mixture. It should also be understood that the material being fused generally includes a fusion flux compound or a mixture of several fusion flux compounds, such that the material to be analyzed can be solubilized upon fusion of the flux material.

In some embodiments, the flux material is a borate compound. In such case, the process may be referred to as a “borate fusion” process. It should be understood that the borate fusion process can include various steps that can be implemented using the fusion system. In a non limiting example, the borate fusion process can include the following steps:
(a) mixing of an inorganic analytical sample with a borate flux (typically lithium-based and/or sodium-based), collectively referred to as a sample, in a crucible (for example a Pt crucible or a Pt-Au crucible);
(b) heating the mixture in the crucible to a temperature between 800° C. and 1300° C., or between 1000° C. and 1200° C., or between 1000° C. and 1100° C., or at about 1050° C., with agitation until the borate flux melts and the inorganic sample dissolves homogeneously into the fused borate flux. It should be understood that the temperature can be selected based on the type of flux material and/or the nature of the sample to be analyzed. The mixture thereby obtained can be referred to as a “fused mixture” or “fused sample”; and
(c) optionally pouring the fused samples from the crucible into a mould.

Commonly-used borate flux materials may be selected from the group consisting of lithium tetraborate (Li₂B₄O₇), lithium metaborate (LiBO₂), sodium tetraborate (Na₂B₄O₇) and combinations thereof, however it will be appreciated that other flux materials could be used and the present disclosure is not limited to use of the flux materials specifically identified herein. The choice of flux material typically depends on the composition of the sample to be analyzed.

Additives can optionally be added to the flux material to modify their properties or to help oxidize partially oxidized elements that can be present in a sample to be analyzed. Non-limiting examples of additives that can be added include the following:
(a) absorbers such as La₂O₃, BaO₂ or SrO can optionally be added to decrease the matrix effect by increasing X-ray absorption of the flux;
(b) fluidizers such as LiF can optionally be added for potentially better transfer of the fused mixture into the mould when preparing an analytical sample for XRF analysis;
(c) internal standards such as various oxides can optionally be added if required in the analytical technique chosen;
(d) oxidizing agents such as NH₄NO₃, NaNO₃, KNO₃, LiNO₃ or Sr(NO₃)₂ can optionally be added to oxidize non-oxidized and/or partially-oxidized inorganic compounds that may be present in the sample to be analyzed; and/or
(e) non-wetting agents such as NaBr, LiBr, KI, Csl, NH₄l or LiI can optionally be added to reduce stickiness to the crucible and allow easier casting.

When oxidizers are used, it may be desirable to pre-heat the flux material/oxidizer/sample mixture to an oxidizing temperature (also referred to herein as a “pre-heating temperature”) that is lower than the fusion temperature and at which oxidizing of the non-oxidized and/or partially-oxidized inorganic elements can occur. For example, in the case of borate flux materials, the oxidizing (or pre-heating) temperature can be set between 150° C. and 1000° C.

For example, when ammonium nitrate is used, the pre-heating of the flux material/oxidizer/sample mixture can be performed at a temperature that decomposes the ammonium nitrate into NO₂ and HNO₃. At least one of these gases can then oxidize the non-oxidized and/or partially-oxidized inorganic elements present in the mixture.

In some embodiments, it can be desirable that a slow decomposition of the oxidizer occurs, as a slow decomposition typically allows for a longer action of the oxidizer on the non-oxidized and/or partially-oxidized inorganic elements present in the mixture. A “slow decomposition” can for example be triggered by first subjecting the flux material/oxidizer/sample mixture to a first temperature that is lower than the temperature of the main fusion step in the heating chamber. The decomposition of the oxidizer can then occur slower at the first temperature than if it had occurred directly at the fusion temperature. Subsequent oxidizing action on the non-oxidized and/or partially-oxidized inorganic elements are prolonged when performed at the first temperature compared to instances where the flux material/oxidizer/sample mixture is directly subjected to the fusion temperature.

It should also be understood that other types of flux materials can be used, such as a peroxide flux material (for example, sodium peroxide Na₂O₂). In such case, the mixture in the crucible can be heated between 450° C. and 650° C. with agitation until the peroxide flux melts and the inorganic analytical sample dissolves homogeneously in the fused peroxide flux.

In some embodiments, the material to be analyzed can include various inorganic materials (also referred to as mineral materials). Non-limiting examples of inorganic materials that can be subjected to the borate fusion process include cement, lime, carbonate, ceramic, glass, slag, refractory material, mining and geological materials, silicate, clay, ores, sulfides, fluorides, bauxite, aluminum, metal-based catalysts, steel, metals, ferroalloys, non-ferrous alloys and mineral/inorganic impurities contained in organic compounds such as polymers or pharmaceutical products.

In the present disclosure, preparing an analytical sample may include the steps of mixing an inorganic sample with a flux material, heating the mixture until the flux material melts and the inorganic sample dissolves into the fused flux material to obtain a fused mixture (sample). Non-limiting examples of “flux fusion” include the “borate fusion” and the “peroxide fusion” examples evoked above.

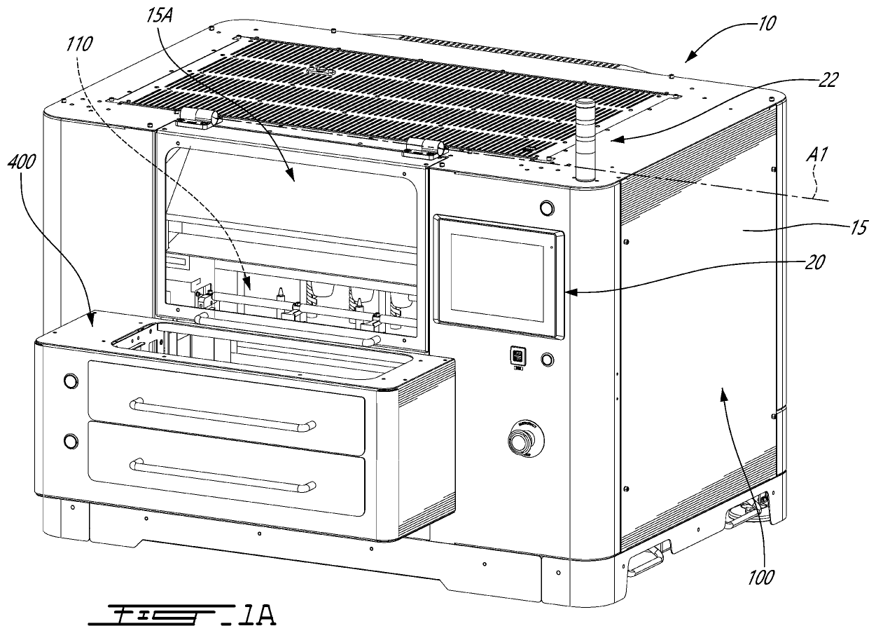

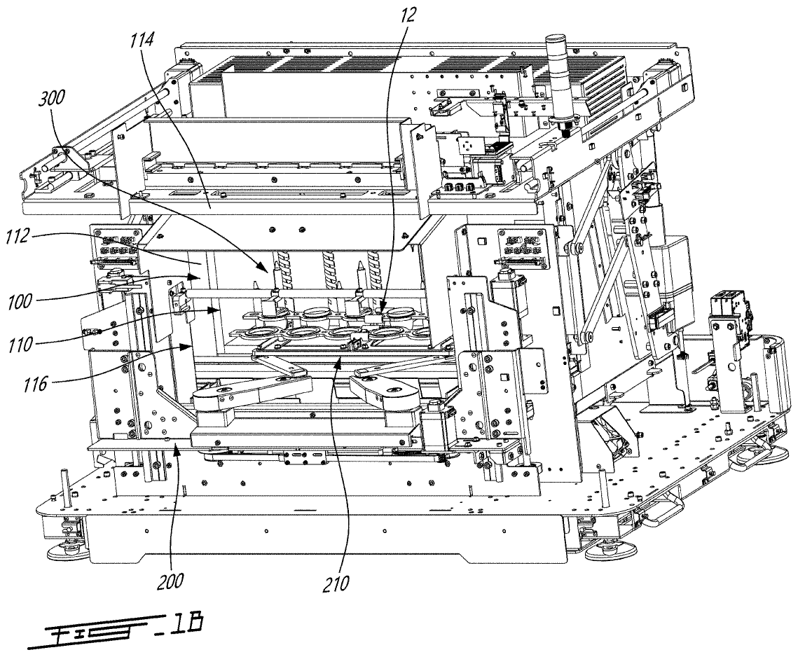

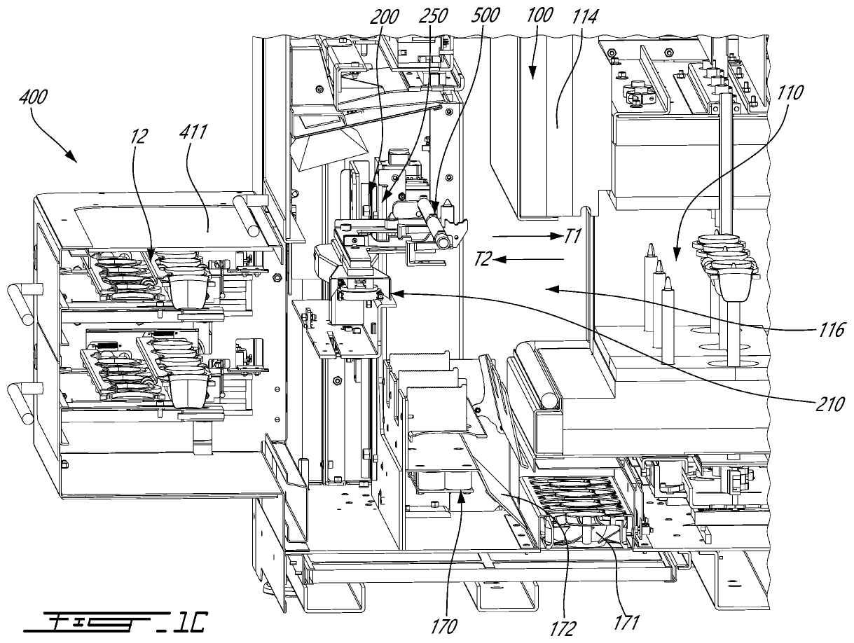

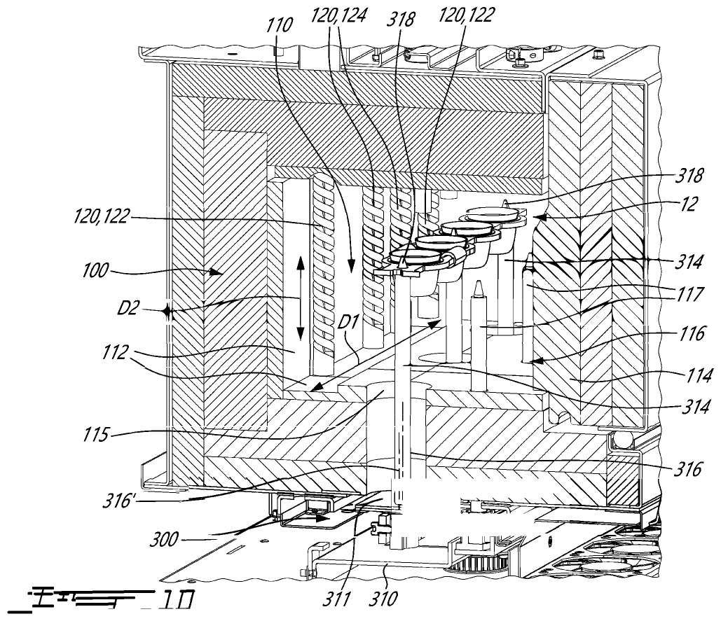

Referring now to FIGS. 1A-1E, an example of a fusion system 10 is depicted including a furnace 100 for generating heat.

The furnace 100 includes a heating chamber 110 provided with heating element(s) 120 (seen in FIG. 1D). The heating chamber 110 is an internal volume of the furnace 100 that is delimited by heating chamber walls 112. In the illustrated embodiment, the heating chamber walls 112 are interconnected at right angles to form a single, cube-shaped heating chamber 110. Other arrangements of the heating chamber walls 112 are possible, and thus so are other shapes for the heating chamber 110. In the illustrated embodiment, one of the heating chamber walls 112 has a door 114. The door 114 can open and close relative a doorway, preferably in a fully or partially automated manner, to provide selective access to the heating chamber 110 through the doorway, as described in greater detail below. The door 114 can be maintained in a closed state during agitating and fusing. The door may include a transparent or translucent section, such as a window, to provide visual access to the heating chamber and allow a person to view the fusion process. In the illustrated embodiment, the heating chamber wall 112 formed by the door 114 is the only heating chamber wall movable portion, the other heating chamber walls remaining fixed relative to one another throughout operation. In this embodiment, the door 114 is a sliding body which translates in the vertical direction to expose the heating chamber 110 and to close it to thereby help thermally insulate or isolate the heating chamber 110 from the environment outside of the furnace 100 during the heating step. Other configurations of the door 114 are possible. For example, the door may open and close by pivoting relative to a hinge, or the door may translate in a generally horizontal direction (in the example embodiment, the movement is slightly oblique from horizontal). In a production environment, available space may be limited or costly, and in some embodiments, using a sliding door rather than a hinged door may help limiting the footprint of the equipment.

In some embodiments, the heating chamber walls and door may be omitted, and the fusion area may not be enclosed within heating chamber walls. For instance, if the heating elements are in the form of fuel nozzles and operate via combustion, the heat may be sufficiently localized onto the crucibles to avoid the necessity of enclosing the crucibles in walls during the fusion operation, and the fusion area may be in the vicinity of such fuel nozzles.

In embodiments where the heating elements are operated to raise or maintain a relatively high temperature in the heating chamber before engaging the sample support with the samples in the heating chamber, the sample support, crucibles, samples and/or moulds or other containers, may be at a significantly lower temperature, such as room temperature, at the time of engagement into the heating chamber. A temperature drop may occur at the time of engaging the sample support(s), crucibles, samples and/or moulds or other containers, into the heating chamber. Such a diminution in temperature may be caused by the opening and closing of the door, and may additionally be caused by absorption of heat from the heating chamber by the sample support, crucibles, samples and/or moulds or other containers. It has been observed, for instance, that putting the samples into the heating chamber 110 can cause the temperature of the heating chamber 110 to temporarily decrease, which can be associated to the need of returning the temperature to the desired temperature for fusion, such that it may be desirable to quickly reach the desired temperature in order to quickly begin the oxidation process. Different factors have an impact on the time it may take to return to the temperature set-point including power delivery in the heating chamber 110 as well as heat loss. The mass of material inserted into the heating chamber 110 may also have an impact on time required to return to the temperature set-point, and/or simply on the overall amount of time required to achieve a given temperature of the samples. The minimal mass that needs to be placed in the heating chamber 110 is the containers (e.g. crucibles) in which the samples (e.g. including flux) are contained, and any support or holder for the containers. In some cases, the samples may be transferred into other containers (e.g. mould, beaker) after fusion, and it can be required to heat such other containers to the same temperature and therefore move it into and out from the heating furnace together with the samples. Accordingly, the minimal mass may further include such other containers and any support or holder therefore. Another factor that may have an impact on returning to or otherwise achieving the temperature set-point is heat loss through/via any opening across heating chamber walls, such as an opening 116 through which the containers are inserted and subsequently received, as described in greater detail below. Other openings in the heating chamber walls 112 may be needed for different reasons including managing the chemical fumes produced during the fusion process, to insert the heating element(s) 120, and more. All these openings may have an impact on the temperature distribution/uniformity inside the heating chamber 110 and therefore may have an impact on the heat transfer to the samples.

In order to minimise heat loss and help achieve uniform temperature distribution within the heating chamber 110, it may be desirable for the putting and removing of the samples into/from the heating chamber 110 to be performed relatively quickly. Performing these operations in a fully or partially automated manner may be helpful in consistently achieving satisfactory loading (and/or unloading) times. It may also be desired to limit the thermal inertia of the sample support(s), crucibles, samples and/or moulds or other containers, and possibly also of any handling mechanism, such as by limiting the mass and specific heat of the materials where feasible/reasonable.

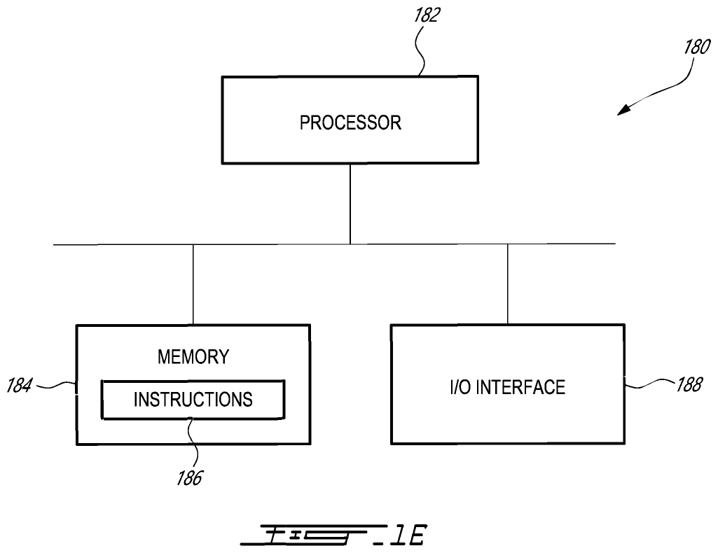

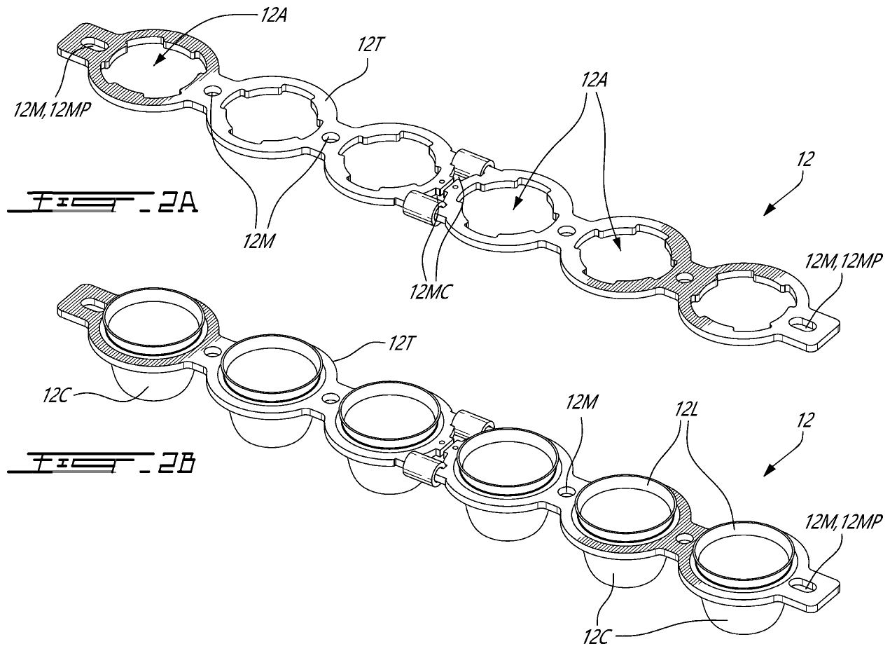

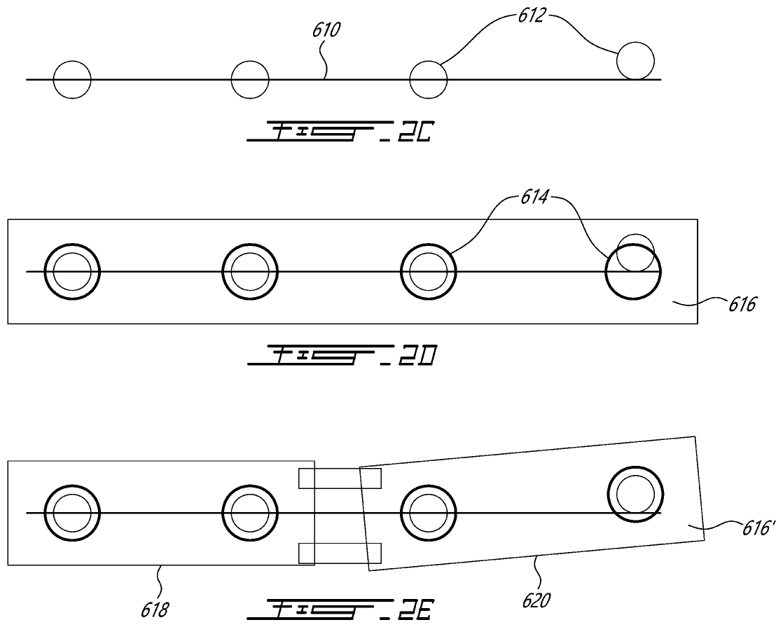

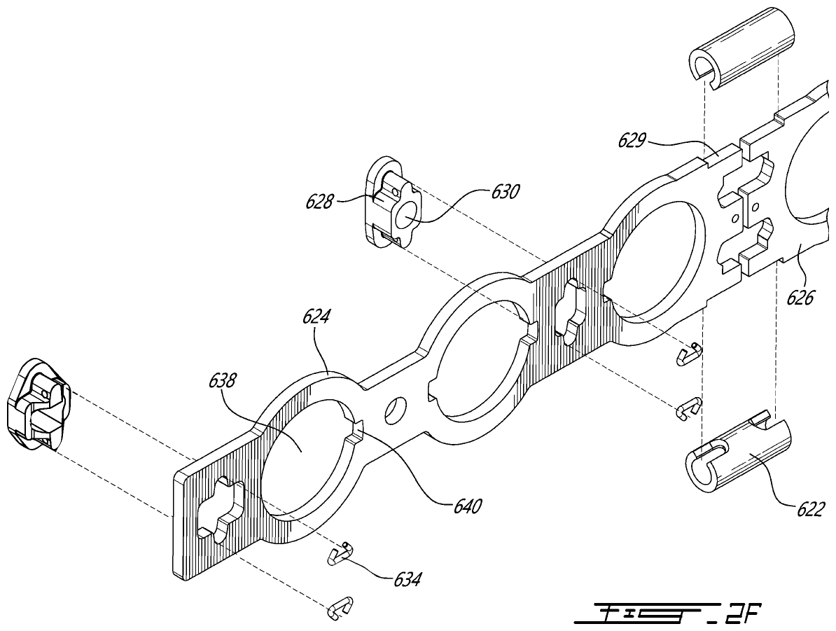

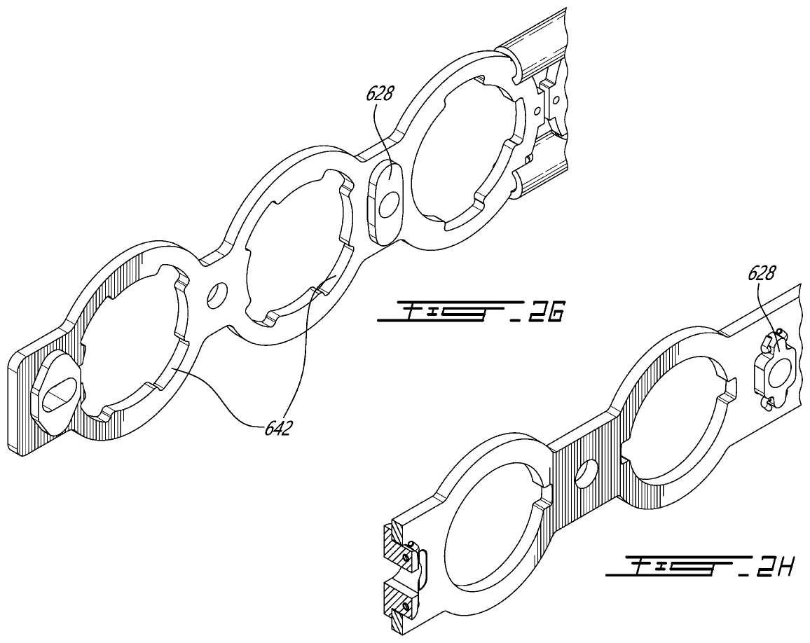

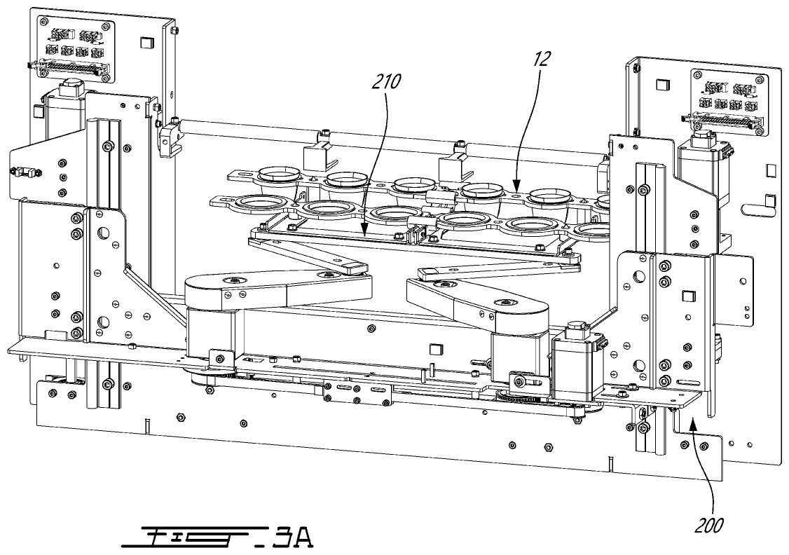

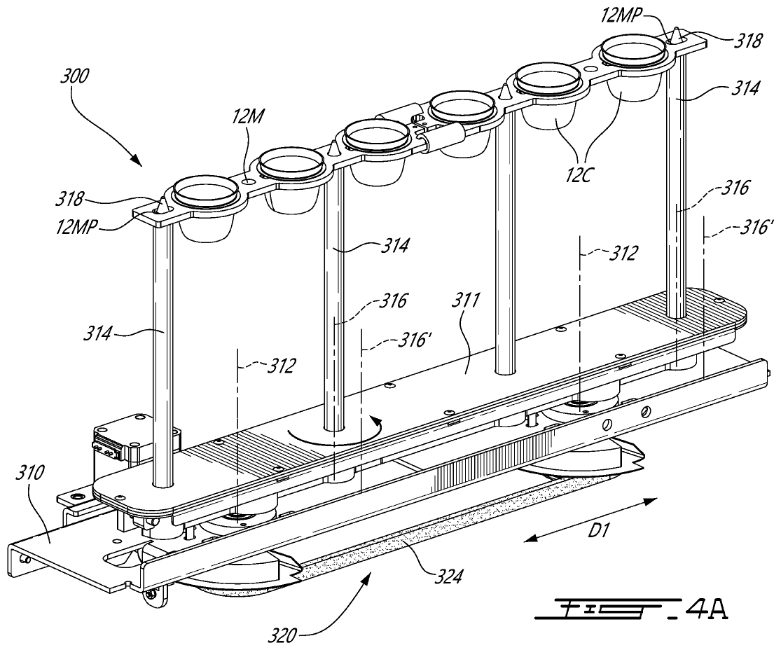

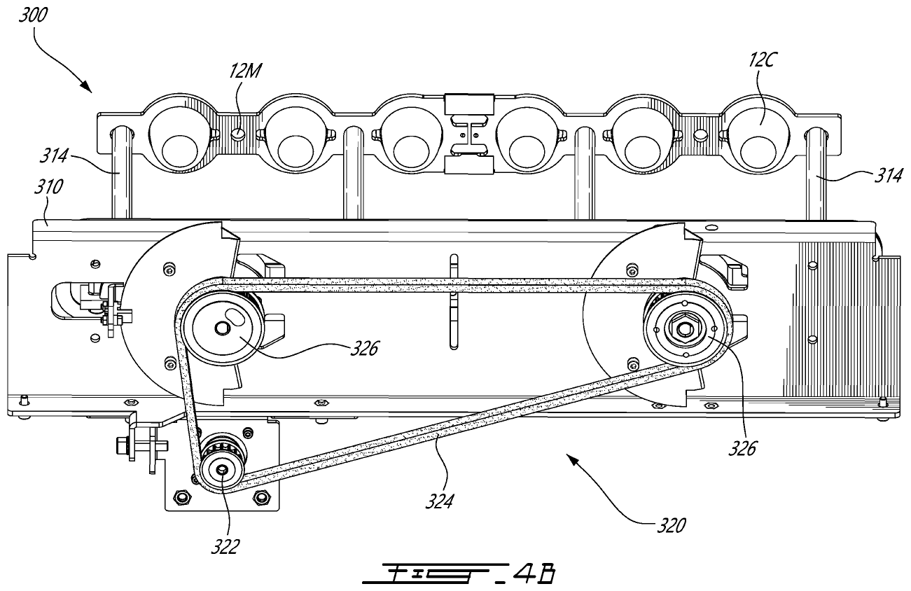

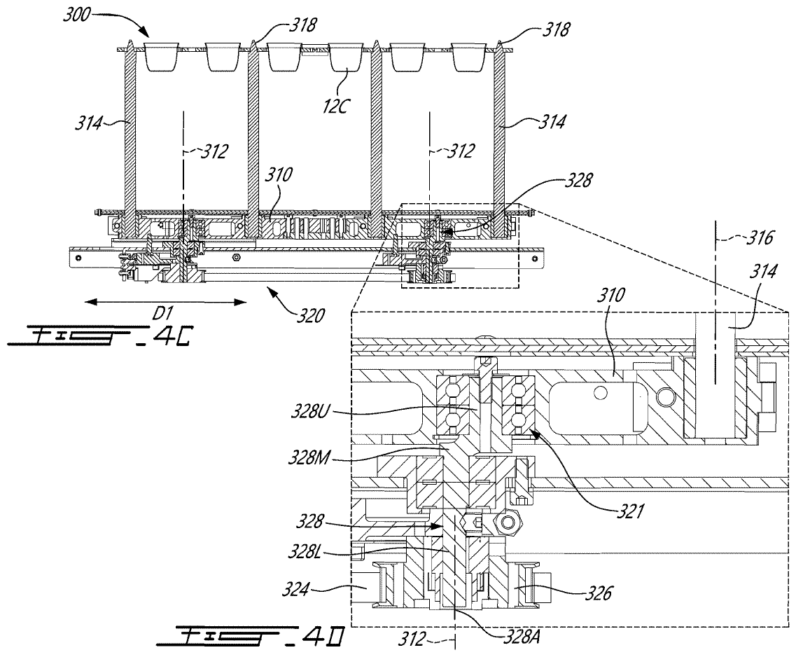

In this specific example, the fusion system has a particular combination of a plurality of features including a handling mechanism 200 (seen in FIGS. 1B and 1C), an agitation mechanism 300 (seen in FIGS. 1D and 4A), a sample holder 12 (seen in FIGS. 2A and 2B), a pouring mechanism 500, and a multiple loading mechanism 400. In this example, all these mechanisms, together with the heating chamber, are enclosed in an outer housing 15, seen in FIG. 1, which may be useful both for health and safety reasons and for giving the system an agreeable finished appearance for instance. Different embodiments can have one or some of these features in any suitable sub-combination. As shown in FIG. 1A, the outer housing 15 may include a safety door 15A. The safety door 15A may include a transparent portion for inspection purposes. The safety door 15A may pivot about an axis A1. The safety door 15A may be opened for cleaning or other operation that may be performed to internal components of the furnace 100.

In this example, the handling mechanism 200 can have a support 210 operable to carry one or more sample holder(s) 12 as the handling mechanism 200 moves the sample holder(s) 12 throughout different steps of the fusion process.

More specifically, and as best seen in FIGS. 2A and 2B, in this example, one (or more) sample holder(s) 12 is provided in the form of a component distinct from both the handling mechanism 200 and the agitation mechanism 300. The sample holder 12 can have a plurality of containers which can be either separable from or integrated with the sample holder. In some embodiments, more than one sample holder 12 can be provided, such as a first sample holder 12 in which the containers are crucibles and a second sample holder in which the containers are moulds or beakers. More specifically, the sample holder(s) 12, the handling mechanism 200, and the agitation mechanism 300 can be operable for the handling mechanism 200 to carry the sample holder(s) via a support as it moves the sample holder(s) into the furnace 100, while a door of the furnace is open, for the handling mechanism 200 to engage the sample holder 12 with the agitation mechanism 300 and to then move the support 210 out from the furnace 100, without the sample holder 12, after which the door can close. At this point, the agitation mechanism 300 can agitate the sample holder 12, with the samples contained therein, during the fusion process. Subsequently to the fusion process, the handling mechanism 200 can move the support back into the furnace, disengage the sample holder from the agitation mechanism 300, and move the sample holder 12 out from the furnace.

Moreover, in this embodiment, the handling mechanism 200 can further be operable to move a first sample holder 12 having the samples into engagement with a pouring mechanism 500, and then disengage from the first sample holder 12. A second sample holder having moulds or beakers can also be provided. The pouring mechanism 500 can then pour the samples into the moulds by pivoting the first sample holder 12 around a horizontal axis. The handling mechanism 200 can then remove the first sample holder 12 from the pouring mechanism 500.

The handling mechanism 200 can move the samples to an optional, dedicated cooling station 170 to expose the samples to a stream of cool air to accelerate cooling.

Moreover, in this embodiment, the multiple loading mechanism 400 can have two or more loading stations for sample holders, and the handling mechanism 200 can be operable to allow to selectively put or remove one or more sample holders from either one of the loading stations in a manner that the loading stations can be loaded or unloaded independently from one another. Indeed, the step of putting the sample holder into a loading area, directly onto the support of the handling mechanism, or putting samples into a sample holder which is in a loading area or supported by a handling mechanism, can be referred to herein as “loading” and the step of removing the sample holder from a loading station, from the support, or of removing solid samples from a sample holder which is in a loading station or on a support, can be referred to herein as “unloading”.

A more detailed description of each one of the features highlighted above will be provided below.

It will be understood that any or all of these features, as well as functions associated to the operation of the furnace itself such as the opening and closing of the furnace door and/or activation and deactivation of heating elements, for instance, can include hardware operable to be controlled in a fully or partially automated manner. To this end, the fusion system 10 can have hardware which will be referred herein as a controller 20. The controller 20 can be operable to perform functions in a partially or fully automated manner. The controller can include a computer, i.e. in the form of a combination of hardware and software elements, or more purely in the form of hardware elements such as electronics. For example, hardware can include logic gates included as part of a silicon chip of the processor. Software can be in the form of data such as computer-readable instructions stored in the memory system. Alternately, hardware can be based more mainly on solid state electronic elements. It will be understood that the expression computer as used herein is not to be interpreted in a limiting manner. It is rather used in a broad sense to generally refer to the combination of some form of one or more processing units and some form of non-transitory memory system accessible by the processing unit(s). The use of the expression computer in its singular form as used herein includes within its scope the combination of two or more computers working communicatively coupled in a manner to collaborate to perform a given function. Moreover, the expression “computer” as used herein includes within its scope the use of partial capacities of a processing unit of an elaborate computing system also operable to perform other functions. Similarly, the expression “controller” as used herein is not to be interpreted in a limiting manner but rather in a general sense of a device, or of a system having more than one device, performing the function(s) of controlling one or more devices.

In the specific example embodiment presented in FIG. 1A, the controller 20 can include a computer 180 such as shown in FIG. 1E, having a processor 182 and a non-transitory memory 184 with functions defined in the form of software instructions 186 stored in the non-transitory memory. The controller 20 can further include a plurality of I/O interfaces 188 such as wired or wireless connections to a display screen, a touchpad or touchscreen, a keypad, a wired or wireless communications module, and a visual or audible alarm unit, to name a few examples.

A controller 20 can be used to control, and fully or partially automate, various phases of the overall process or cycle associated with fusion of the samples for various reasons, such as safety, or productivity. Indeed, each phase of the process, whether putting the samples onto the handling mechanism 200, putting the samples onto the agitation mechanism 300, performing the fusion, removing the samples after the fusion, pouring the fused mixture from crucibles into moulds, and/or cooling the samples, for instance, can take a certain amount of time which can cumulatively add up in defining an overall cycle duration, and reducing cycle duration can be a significant factor in increasing the productivity of a given fusion system.

Depending on the embodiment, the automated or semi-automated movement of hardware components can be based on feedback from one or more sensors, for instance (e.g. servomotor, proximity sensors), or can be automated based on prior calibration, to name some examples. In some embodiments, the controller 20 can have a function to trigger an alarm based on an indication received from one or more sensor, which can be based on conditions defined in a set of instructions stored in the non-transitory memory of the controller for instance (e.g. handling mechanism is blocked, or has not reached a given intended position). Such an alarm can be in the form of a visual and/or audible indicator, e.g. trigger the activation of a graphical user interface element on the display screen, or trigger a given level of alarm on a light tower indicator 22, such as an orange or red light alarm for instance.

In an embodiment where the fusion system 10 has a heating chamber with a door, 114, the controller 20 can be connected to actuators of the door 114 in a manner to control the opening and closing of the door 114 in a partially or fully automated manner. This control can be performed in a timed manner with the control of other mechanisms, such as the handling mechanism 200, the heating elements 120, and/or the agitation mechanism 300 for instance. One or more door sensors can further be included within the fusion system 10 and communicatively coupled to the controller. Such sensors can include hardware and/or software elements, and can be operable to allow the controller to confirm intended operation of the door (e.g. door successfully open, door successfully closed), and/or allow the controller to determine an event of unintended operation of the door (e.g. door not successfully closed or door not successfully open). Such a determination or indication at the controller can be used by the controller in various ways, such as trigger the generation of a visible or audible indication (e.g. trigger the activation of a graphical user interface element on the display screen, or trigger a given level of alarm on a light tower indicator 22, such as an orange or red light alarm), and/or be used as a condition for allowing the accomplishment of further automated steps (e.g. the handling mechanism 200 will be controlled by the controller to penetrate into heat chamber only if the door is confirmed to have been successfully opened, or the heating elements 120 will be controlled by the controller to activate/generate fusion heat only if the door is confirmed to have been successfully closed).

The heating element(s) 120 can be operable to generate heat and raise the temperature of the heating chamber 110. Referring to FIGS. 1B and 1D, the heating element(s) 120 include multiple heating elements 120 which are at least partially disposed within the heating chamber 110. The heating elements 120 are spaced apart from one another in a first lateral direction D1. The heating elements 120 are elongated bodies extending in an upright or vertical direction D2 that is transverse to the first lateral direction D1. The heating elements 120 are resistive and generate heat resulting from resistance to an electrical current flowing through the heating elements 120. The furnace 100 is a resistive-heating furnace. In an alternate embodiment, the heating can be provided by fuel combustion rather than electrical resistance, for instance.

In one embodiment, the one or more heating elements 120 can be controlled by the controller 20 in a fully or partially automated manner. Depending on the embodiment, the heat element control process can be based on feedback from one or more temperature sensors located in the heating chamber, for instance, or can be automated based on prior calibration, to name some examples. In some embodiments, the controller 20 can have a function to trigger an alarm based on an indication received from a temperature sensor, which can be based on conditions defined in a set of instructions stored in the non-transitory memory of the controller for instance. Such an alarm can be in the form of a visual or audible indicator, e.g. trigger the activation of a graphical user interface element on the display screen, or trigger a given level of alarm on a light tower indicator 22, such as an orange or red light alarm for instance.

The temperature of the heating chamber 110 is a factor in the fusion process, such that it may be desirable for the heat transfer to the crucibles holding the samples to be uniform and properly distributed throughout the heating chamber 110. This may be achieved by controlling the size and placement of any openings leading to the heating chamber 110 so as to control the airflow inside the heating chamber 110. This may also be achieved by spacing the heating elements 120 in a desired arrangement, such that the crucibles containing the samples are placed in such a way that the distance between the heating elements 120 and the crucibles is uneven. For example, and referring to FIG. 1D, the heating elements 120 include two peripheral heating elements 122 which are disposed furthest from each other in the first lateral direction D1 and which are spaced closest to opposite heating chamber walls 112. The heating elements 120 include two middle heating elements 124 positioned adjacent to each other and in between the peripheral heating elements 122 relative to the first lateral direction D1. The spacing between the heating elements 122,124 in the first lateral direction D1 is not consistent. The spacing in the first lateral direction D1 between each peripheral heating element 122 and its nearest middle heating element 124 is greater than the spacing in the first lateral direction D1 between the two middle heating elements 124. Thus, the spacing in the first lateral direction D1 is smallest between both heating elements 124 nearest to the centre of the heating chamber 110. Another way of addressing uniformity of temperature in the heating chamber 110 is by providing heating elements which are evenly or unevenly interspaced from one another, but which are powered at different levels of electrical power to compensate for any element of the system's construction which may otherwise lead to unsatisfactory heat distribution within the heat chamber during cooling.

Although an embodiment described herein is an electrically-powered fusion system 10 (i.e., due to the heating elements 120 being of the electrical-resistance type), it will be appreciated that other configurations are possible. For example, the heating element(s) 120 may generate heat for the heating chamber 110 by combusting a fuel, such as gas. In such an embodiment, the heating element(s) 120 may include a combustor, one or more opening(s) in the heating chamber walls 112 through which hot air is admitted, and/or an exhaust for evacuating the hot combustion gases away from the heating chamber 110. In such embodiments, an enclosure specifically delimiting a heating chamber may not be present, and the crucibles (and potentially the moulds as well) can be exposed directly to a specifically oriented flame during heating in a broader area such as a room in a building. In such an embodiment, the fusion system 10 may be described as a gas fusion system 10, or a gas fluxer. In yet another possible configuration of the heating element(s) 120, the furnace 100 has only one heating element 120. In yet another possible configuration of the heating element(s) 120, the heating element(s) 120 have a horizontal orientation when extending through the heating chamber 110. It will thus be appreciated that the configuration of the heating element(s) 120 may vary, provided that it/they achieve the function of heating the fusion area.

The opening 116 can be provided in the form of an archway which is temporarily made accessible to allow for the passage of the support 210 and the sample holder 12 into and out of the heating chamber 110, and which is closed off or inaccessible when the support 210 is outside of the heating chamber 110. For example, and referring to FIG. 1B, the opening 116 is formed or is accessible when the door 114 is in an open position, and the opening 116 is closed or inaccessible when the door 114 is in a closed position. The support 210 is capable of displacing into, and retracting from, the heating chamber 110 via the opening 116. The support 210 is thus operable to pass through at least one of the heating chamber walls 112 defining the heating chamber 110. By employing a support 210 to displace and deposit the sample holder 12 in the heating chamber 110, the handling mechanism 200 can be fully retracted out from the heating chamber 110 during fusion and not be used for holding, supporting, or agitating the sample holder 12 during the fusion phase.

It can be desired to reduce the mass which is moved into the fusion area of the furnace, heated to the desired temperature for fusion, and subsequently moved out from the fusion area, in a manner to improve temperature stability within the furnace, reduce fusion time, or both. Indeed, the mass which is moved into and out from the fusion area can be associated to the mass which absorbs heat from the furnace, and reducing this mass may directly reduce the amount of heat which needs to be supplied by heating elements to achieve a given temperature. One way of reducing this mass is to provide a sample holder which is relatively minimalist in terms of mass and a handling mechanism which has a base located outside the fusion area, but which can move the sample holder into and out from the fusion area, and which can be entirely retracted out from the furnace (fusion area) during the fusion operation in a manner to avoid contributing to the mass which is to be heated. In one example, an agitation mechanism 300 which has hardware elements which are entirely distinct from hardware elements of the handling mechanism 200, can be associated with the fusion area, and the handling mechanism 200 can be further operable to engage the sample holder 12 with the agitation mechanism 300 prior to fusion, and to disengage the sample holder 12 from the agitation mechanism 300 subsequently to fusion.

For instance, during use, samples (e.g. inorganic sample and flux) can be loaded into containers held in a sample holder 12. The containers can be separable from the sample holder 12, or integral to the sample holder 12 depending on the embodiment. The sample holder 12 can be put onto a support 210 of the handling mechanism 200. The handling mechanism 200 can be operable to move the support 210 into and out from a fusion area of the furnace 100. The handling mechanism 200 can be operable to move the support 210 towards and away from a base of the handling mechanism, and the base of the handling mechanism can be located outside of the fusion area, e.g. outside the furnace 100. The support 210 can carry the sample holder 12 while the handling mechanism 200 moves the support 210 and the sample holder 12. The handling mechanism 200 can engage the sample holder 12 with the agitation mechanism 300, at which point it (the support 210) can simultaneously disengage from the sample holder 12, and then move out from the fusion area. The furnace 100 can be activated to generate heat which fuses the samples, which can involve generating heat to reach, maintain, or return to a certain temperature set point for instance, and the agitation mechanism 300 can agitate the samples during the fusion. Once the fusion is complete, the handling mechanism (via support 210) can disengage the sample holder 12 from the agitation mechanism 300, and move the sample holder 12 out from the furnace 100, to a location where they can be cooled and/or picked up by an operator.

More specifically, a door of the furnace can be opened prior to the moving of the support 210 into the fusion area, be kept open during the engagement of the sample holder 12 with the agitation mechanism 300 and the moving of the support 210 out from the fusion area, closed during the fusing, and reopened for the steps of moving the support 210 back into the fusion area, disengaging the sample holder 12 from the agitation mechanism 300, and moving the sample holder 12 out from the fusion area. Such process steps can be fully or partially automated via a controller 20, which can contribute to reducing the duration of the process steps and/or facilitating the coordination between the action of the door, the action of the handling mechanism 200, and the action of the agitation mechanism 300. Engaging the sample holder 12 with the agitation mechanism 300 can involve lowering the sample holder 12 onto the agitation mechanism 300 whereas disengaging the sample holder 12 from the agitation mechanism 300 can involve raising the sample holder 12 from the agitation mechanism 300, as will be exemplified below.

Referring to FIG. 1B, the handling mechanism 200 can be provided in the form of an assembly of components which function/cooperate together to achieve the function of handling the sample holder 12. The handling mechanism 200 has a support 210 which is operable to support the sample holder 12 while the sample holder 12 is displaced into and out from the fusion area such as can be enclosed by a heating chamber 110. The support 210 can further support the sample holder 12 while the sample holder 12 is moved to or from other locations, such as a loading area, cooling area (e.g. cooling station 170) and a pouring station 500, depending on the details of the specific embodiment. Some components of the handling mechanism 200 remain permanently outside of the heating chamber 110, as explained in greater detail below. However, the support 210 can be moved into and out from the heating chamber 110. In an embodiment, the support 210 only temporarily remains within the heating chamber 110, for the purpose of putting or removing the sample holder 12 in/from the heating chamber 110. In an embodiment, the support 210 is not present in the heating chamber 110 during the fusing of the sample or when heat is being generated by the heating element(s) 120. By remaining outside of the heating chamber 110 while heat is generated, the mass of the support 210 does not contribute to absorption of heat energy during the heating step which can help to reduce the time for the heating chamber 110 to achieve or recover its desired or set-point temperature once the sample holder 12 and the samples have been loaded therein. The support 210 may take any suitable form or be any suitable arrangement of components to achieve its function, and at least one possible configuration for the support 210, operable here specifically to collaborate with the particulars of the sample holder 12 and with the particulars of the agitation mechanism 300 of the illustrated embodiment is described in greater detail below.

In one embodiment, the handling mechanism 200 can be controlled by the controller 20 in a fully or partially automated manner. Depending on the embodiment, the handling mechanism control process can be based on feedback from one or more sensors, for instance (e.g. servomotor, proximity sensors), or can be automated based on prior calibration, to name some examples. In some embodiments, the controller 20 can have a function to trigger an alarm based on an indication received from a handling mechanism sensor, which can be based on conditions defined in a set of instructions stored in the non-transitory memory of the controller for instance (e.g. handling mechanism is blocked, or has not reached a given intended position). Such an alarm can be in the form of a visual and/or audible indicator, e.g. trigger the activation of a graphical user interface element on the display screen, or trigger a given level of alarm on a light tower indicator 22, such as an orange or red light alarm for instance. The handling mechanism control process can be coordinated with other control processes such as a door control process, a pouring mechanism control process, a cooling station control process and/or an agitation mechanism control process.

In one embodiment, the door can be controlled by the controller 20 in a fully or partially automated manner. Depending on the embodiment, the door control process can be based on feedback from one or more sensors, for instance (e.g. servomotor, proximity sensors), or can be automated based on prior calibration, to name some examples. In some embodiments, the controller 20 can have a function to trigger an alarm based on an indication received from a door sensor, which can be based on conditions defined in a set of instructions stored in the non-transitory memory of the controller for instance (e.g. handling mechanism is blocked, or has not reached a given intended position). Such an alarm can be in the form of a visual and/or audible indicator, e.g. trigger the activation of a graphical user interface element on the display screen, or trigger a given level of alarm on a light tower indicator 22, such as an orange or red light alarm for instance. The door control process can be coordinated with other control processes such as a handling mechanism control process, a heating element control process and/or an agitation mechanism control process.

The sample holder 12 can be operable to being selectively supported by either one of the handling mechanism 200 and the agitation mechanism 300 (and optionally via additional mechanisms such as a cooling station, a pouring mechanism 500, or a multiple loading mechanism 400). The sample holder 12 can be operable to be transferred from one mechanism to another in an automated manner which, in this specification, can be referred to as engaging or disengaging the sample holder 12 with the corresponding mechanism by action of the handling mechanism. In one embodiment, the sample holder support and transfer scheme can be based on upright rods having terminal ends used for selectively supporting the sample holder by a corresponding one of the mechanisms, and the sample holder having corresponding sockets operable to be engaged by the terminal ends of the rods.

One example of a possible configuration for the sample holder 12 is shown in FIGS. 2A and 2B. In this example embodiment, the sample holder can have containers which can be removably nested within corresponding ones of container receptors. More specifically, different types of containers can be sized in a manner to fit container receptors, such as crucibles, moulds, beakers, etc. In other embodiments, different models of sample holders can be associated to different kinds of separable containers. In still another embodiment, the containers can be integrated to the sample holder. In the embodiment illustrated, the sample holder engagement scheme can be based on upright rods having terminal ends used for selectively supporting the sample holder, and the sample holder having corresponding sockets (e.g. rod sockets) operable to be engaged by the terminal ends of the rods. The sockets can be mounting apertures and can be opened (e.g. through apertures) or closed. In some embodiments, the sockets can be male and the terminal ends can be female. In some embodiments, the terminal ends of the rods can be tapered, e.g. conical, pyramidal, truncated conical or truncated pyramidal, whereas in other embodiments other mating shapes between the rods and sockets can be used. It will be appreciated that other configurations of the sockets and rod engagement schemes are possible.

In the illustrated embodiment, as seen in FIG. 1D, the agitation mechanism can have a plurality of upwardly oriented agitation rods, and the sample holder can be provided with a first set of upwardly oriented sockets operable to receive terminal ends of the agitation rods.

As seen in FIG. 1C, the handling mechanism, and more specifically the support, can have a plurality of upwardly oriented handling rods, and the sample holder can have a second set of sockets operable to receive terminal ends of the handling rods. The direction of movement into and out from the fusion area can be characterized as of horizontal and longitudinal orientation, in which case the handling rods and the second set of sockets can be characterized as horizontally and laterally offset from the agitation rods and the first set of sockets, for the agitation rods to be out from interference with the longitudinal displacement of the handling rods. Accordingly, the handling rods can be supported by corresponding, longitudinally oriented prongs of the support, which can be directed towards the fusion area.

FIG. 1D presents further details of an example of an agitation mechanism 300 operable to receive the sample holder 12 from the support 210 of the handling mechanism 200 and for agitating the sample holder 12, and thus the samples, independently of the handling mechanism 200, during the fusion phase. The engagement of the sample holder 12 with the agitation mechanism 300, which can be provided here by vertically lowering the sockets into engagement with the terminal ends of the rods, allows the sample holder 12 to be fully supported by the agitation mechanism 300, thereby allowing the support 210 of the handling mechanism to be thereafter moved out from the heating chamber 110. Thus, the sample holder 12, with the containers and any samples contained therein are deposited inside the heating chamber 110 on a feature of the agitation mechanism 300 which remains inside the heating chamber 110 throughout a given instance of the fusion process. During the step of fusing the samples, the agitation mechanism 300 can agitate the sample holder 12 and the samples it contains while they are within the heating chamber 110, and while the heating element(s) 120 can be controlled in a manner to heat the heating chamber 110 or otherwise achieve a target temperature in the vicinity of the sample. Depending on the embodiment, the agitation mechanism 300 may constitute of various collections or assemblies of components which function/cooperate together to achieve the function of agitating the sample during the fusing. At least one possible configuration of the agitation mechanism 300 is described in greater detail below.

In one embodiment, the agitation mechanism 300 can be controlled by the controller 20 in a fully or partially automated manner. Depending on the embodiment, the agitation mechanism control process can be based on feedback from one or more sensors (e.g. servomotors, motion detectors), for instance, or can be automated based on prior calibration, to name some examples. In some embodiments, the controller 20 can have a function to trigger an alarm based on an indication received from a sensor associated to the agitation mechanism 300, which trigger can be based on conditions defined in a set of instructions stored in the non-transitory memory of the controller 20 for instance. Such an alarm can be in the form of a visual and/or audible indicator, e.g. trigger the activation of a graphical user interface element on the display screen, or trigger a given level of alarm on a light tower indicator 22, such as an orange or red light alarm for instance.

Referring back to FIGS. 2A and 2B, a specific embodiment of a sample holder 12, a tray 12T which is operable to carry crucibles 12C, is presented. The tray 12T has multiple apertures 12A (six are shown, but more or fewer apertures 12A are possible), each aperture 12A forming a container receptor operable to receive a corresponding crucible. FIG. 2B shows the sample holder with the crucibles 12C received in the apertures 12A. More particularly, in this example embodiment, each crucible 12C has a crucible lip 12L which has a diameter larger than the diameter of the aperture 12A. The crucible 12C may be placed into the aperture 12A, and the crucible lip 12L rests against part of the tray 12T so that the crucible 12C is supported by the tray 12T. Accordingly, in this embodiment, each crucible 12C is removably mounted to a corresponding sample aperture 12A of the tray 12T. Referring to FIG. 2B, all of the crucibles 12C are shown having the same shape and size. It will be appreciated that the crucibles 12C may have different shapes and may be any receptacle, vessel or container for supporting a sample to be fused. It will also be appreciated that the tray 12T may support containers of different shapes or configurations, such as moulds or beakers. One or more of the crucible(s) 12C may contain or support more than one sample to be fused. The tray 12T has mounting apertures 12M which are used to engage the sample holder with one or more mechanism(s) or station(s) of the fusion system 10. The mounting apertures 12M include peripheral mounting apertures 12MP which are positioned at opposite extremities of the tray 12T. The peripheral mounting apertures 12MP have a shape which is different from the shape of the other mounting apertures 12M. In this embodiment, the peripheral mounting apertures 12MP are obround (i.e. racetrack shaped with a rectangle aperture between two semi-circular apertures), whereas the other mounting apertures are circular, although it will be appreciated that other mounting aperture and peripheral mounting aperture shapes are also possible.

Referring back to FIG. 1C, in the embodiment illustrated, the handling mechanism 200 includes both a horizontal displacement mechanism, operable to move the samples into and out from the heating chamber along a longitudinally oriented ingress and egress path, when the door 114 is open, and an upright displacement mechanism, operable to move the samples along the vertical orientation. The expressions horizontal and upright are used here for simplicity, and it will be understood that the orientations can be partially oblique from horizontal or vertical in some embodiments while still being considered generally horizontal or generally upright. The upright displacement mechanism may be omitted in some embodiments. In the embodiment illustrated, the upright displacement mechanism can be used to lower the sample holder 12 into engagement with the agitation mechanism 300, or raise the sample holder 12 out from engagement with the agitation mechanism 300, while the horizontal displacement mechanism can be used to move the support, with or without the sample holder, into and out from the fusion area.

One possible configuration of the agitation mechanism 300 is now described with reference to FIGS. 4A to 4D. The agitation mechanism has an agitation base 310 and a rod support 311 that is operable to rotate partially (i.e. less than 360 degrees) or fully (360 degrees) about an agitation axis 312. More specifically, the agitation mechanism can revolve terminal end agitation rods, including the terminal ends thereof which receive the sample holder, around upwardly oriented virtual axes so as to mix the sample materials during the fusion process. The agitation mechanism can revolve agitation rods in a back and forth manner in alternating opposite angular orientations, such as during partial rotations, or continuously, over several rotations in a same angular orientation, to name some examples. The terminal ends can undergo a circular or ellipsoid path in a horizontal plane, for instance, depending on whether the upwardly oriented virtual axes are vertical or oblique. The agitation axis 312 extends in an upright or vertical direction, such that the rod support 311 is moved along a circular path within its plane, relative to the base 310, and the plane can be horizontal and perpendicular to the agitation axis 312. In one embodiment, it can be preferred for the revolving path to be circular. Referring to FIGS. 4A to 4D, the rod support 311 is an elongated, rectangular body that extends along the first lateral direction D1. The rod support 311 has mounts (e.g. openings or grooves) for receiving one or more agitation rod(s) 314 such that the agitation rod(s) 314 are fixedly mounted to the rod support 311 (i.e. there is no relative movement between the rod support 311 and the agitation rod(s) 314). The agitation mechanism 300 is shown as having four agitation rods 314, but more or fewer agitation rods 314 are possible in alternate embodiments. Each agitation rod 314 has an elongated body that extends upright from the rod support 311 to a terminal end along a rod axis 316. The circular motion of the agitation base 310 within its plane (e.g. around the perpendicularly oriented agitation axes 312) is transferred to the agitation rods 314 and the rod axes 316 can be said to rotate around virtual axes 316′ which are fixed relative to agitation base 310. The agitation rods 314 are spaced apart from each other along the base 310 and within the heating chamber 110 along a direction parallel to the first lateral direction D1. The agitation rods 314 are equidistantly spaced apart from each other along the base 310 in a direction parallel to the first lateral direction D1.

As best seen in FIG. 1D, the rod support 311 and the agitation base 310 can be positioned outside of the heating chamber 110 to protect it from high temperatures which may exist during fusion within the heating chamber, and the agitation rods 314 can extend into the heating chamber via agitation rod apertures defined through refractory material of the heating chamber walls. The agitation rod apertures can be larger than the size of the agitation rods 314 so as to accommodate the circular motion of the rods 314 around the virtual axes 316′. A distal portion of each agitation rod 314 can be permanently disposed within the heating chamber 110. In the embodiment presented in FIG. 1D, most of the length of each agitation rod 314 extends in the heating chamber 110. In an embodiment, all of the length of each agitation rod 314 is present in the heating chamber 110 except for the portion of each agitation rod 314 that is mounted to, or within, the rod support 311.

The terminal end of each agitation rod 314, which is present in the heating chamber 110, is operable to support the sample holder 12 while it holds the samples. The terminal end forms or otherwise has an attachment 318 supporting the sample holder 12, and the attachment 318 may take different configurations. For example, and referring to FIG. 4A, each of the attachments 318 has or forms a conical or pointed end of the agitation rods 314. The attachments 318 of agitation rods 314 are operable to be inserted into mounting apertures 12M of the tray 12T of the sample holder 12 in this embodiment. The mounting apertures 12M have a diameter that is smaller than the diameter of the agitation rods 314, such that the tray 12T with the samples is able to rest on the agitation rods 314 and be supported by the agitation mechanism 300 inside the heating chamber 110. Other configurations are possible. In this embodiment, and as will be explained in greater detail below, attachments provided at terminal ends of rods of the support 210 can be similar to the attachments 318, thereby providing uniformity between the handling mechanism 200 and the agitation mechanism 300. Other configurations of the attachments 318 are possible and the attachments of the agitation rods can be different from the attachments of the support rods in alternate embodiments. Accordingly, the agitation mechanism 300 can be operable to receive the sample holder 12 from the support 210 of the handling mechanism 200, and to support the sample holder 12 within the heating chamber 110.

Referring to FIG. 1D the fusion area can further be provided with fixed support rods 117 in addition to the agitation rods 314. The agitation rods 314 can be operable to receive a sample holder bearing a first type of container, such as crucibles which hold the samples during fusion, for instance, whereas the fixed support rods 117 can be used to support a sample holder bearing a second type of container, such as moulds or beakers which may need to be at the same temperature as the sample when the sample is poured thereinto. The fixed support rods 117 can be secured to the bottom wall of the heating chamber for instance. The fixed support rods 117 can be used to receive a mould support, which supports a plurality of moulds which do not need to be agitated, but which may benefit from being at a similar temperature than the samples when the samples are poured from the crucibles into the moulds. The agitation rods 314, which can be used to agitate a sample holder bearing the crucibles with the samples inside during fusion in such an example, can be spaced apart from support rods 117 in a direction transverse to the first lateral direction D1. The fixed support rods 117 have an upright orientation and are parallel to the agitation rods 314 in the heating chamber 110. The fixed support rods 117 are permanently positioned within the heating chamber 110 and are immobile throughout the fusion process. In this embodiment, the height of the agitation rods 314, measured from the bottom heating chamber wall to the attachments 318 in a direction parallel to the vertical direction D2, is greater than the height of the fixed support rods 117. The shorter fixed support rods 117 may have similar pointed-end or conical attachments at their terminal ends so as to receive a sample holder bearing moulds having volumes into which the samples may be poured, as explained in greater detail below, so that the moulds can be heated along with the samples. The shorter fixed support rods 117 are not agitated by the agitation mechanism 300.

Referring to FIG. 2A, the sample holders can have a plurality of downwardly-oriented sockets operable to engage the terminal ends of the agitation rods 314, or the terminal ends of the support rods 117 for instance. The downwardly-oriented sockets can take the form of mounting apertures for example. The sample holders can further have container receptors, such as apertures operable to snugly receive a crucible or a mould, for instance, and can have narrower neck portions adjacent the container receptors.

The configuration, including relative positioning, of the terminal ends of the agitation rods 314 can be operable to provide a mating engagement with receiving features of the sample holder. For instance, the terminal ends of the agitation rods can be interspaced from one another in a similar manner as mating mounting apertures provided in a sample holder are interspaced from one another, to allow the sample holder to fit the terminal ends. If fixed support rods 117 are used, they can similarly be operable to engage corresponding ones of receiving features in a mould holder/support, for instance.

In one embodiment, the handling mechanism can be operable to move and transfer the sample holder(s) with a support 210. The support can also have upwardly oriented rods, which can be referred to as handling rods for instance. The sample holder can have distinct sets of sockets, such as a first set of sockets operable to receive the agitation or fixed support rod terminal ends, and a second set of sockets operable to receive the handling rods. The sockets of the second set can be laterally offset from the sockets of the first set, as the handling rods can be laterally offset from the agitation or fixed support rods to provide for the step of transferring the sample holder from the handling mechanism to the agitation mechanism or support rods for instance. Indeed, in the course of this transfer, the handling rods can be brought into an interspersed configuration (i.e. with one or more handling rods being between agitation rods or vice-versa) with the agitation rods (or fixed support rods), with the sample holder being above the agitation rods (or fixed support rods), and then the support of the handling mechanism can be brought down to place the first set of sockets into engagement with the agitation rods (or fixed support rods), and disengage the second set of sockets from the handling rods, at which stage the support can be withdrawn from the fusion area. The handling rods can be secured to longitudinally oriented prongs directed towards the fusion area in a manner that neither the prongs, nor the handling rods, come into interference with the fixed support rods or agitation rods, but rather mesh with them when the support is moved into the fusion area.

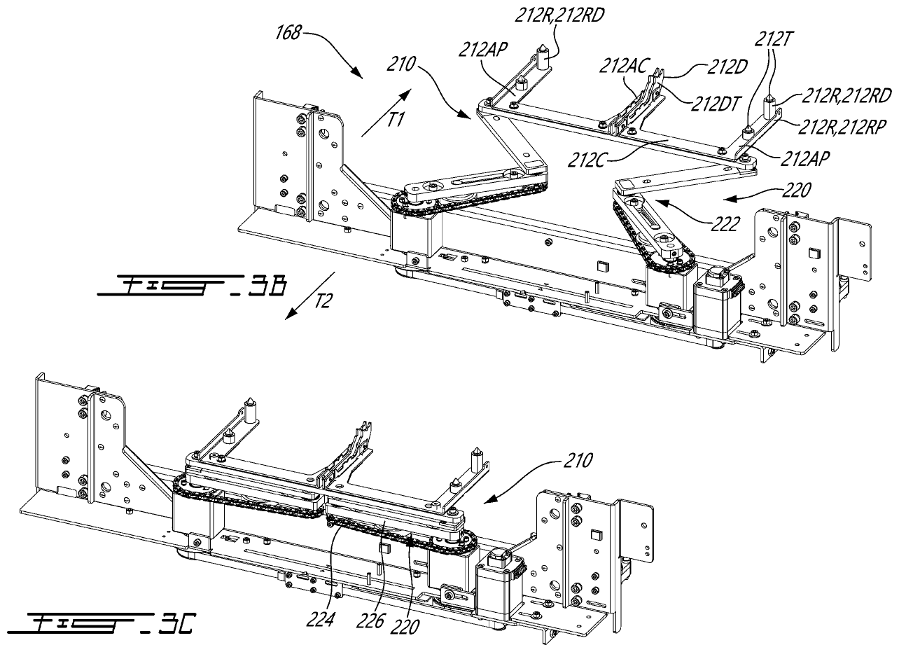

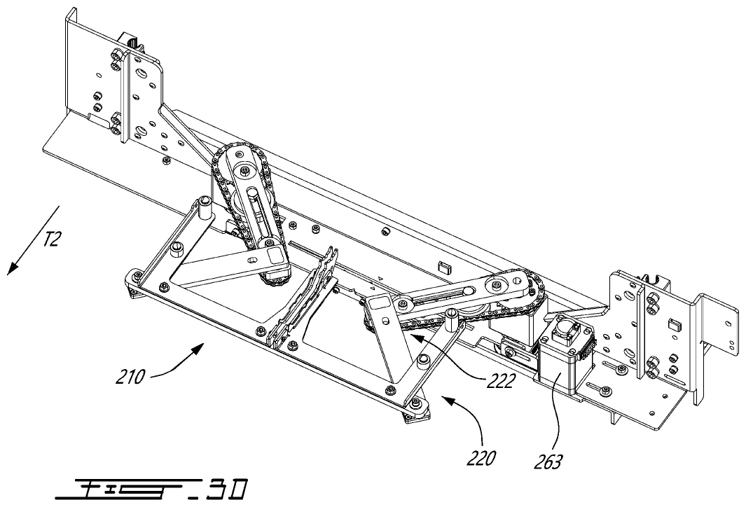

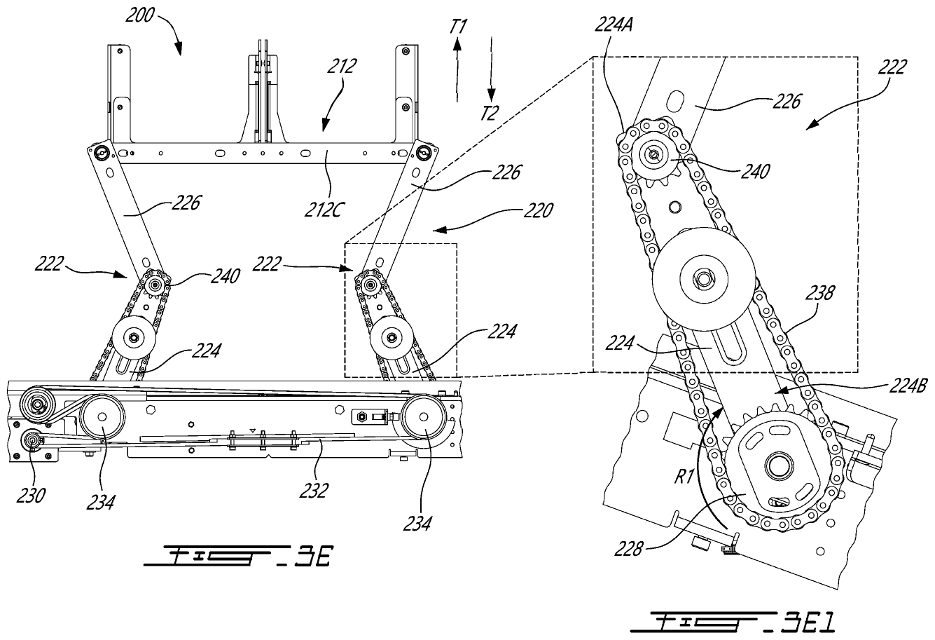

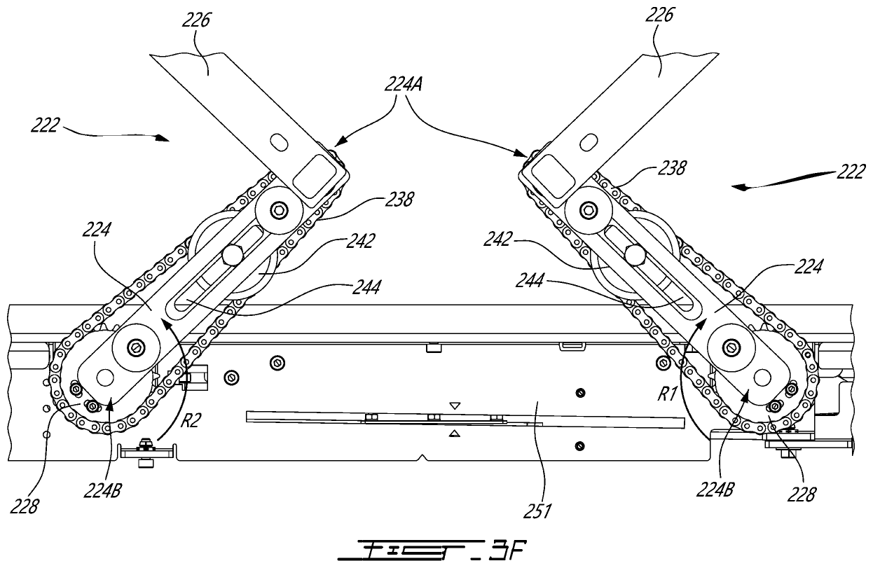

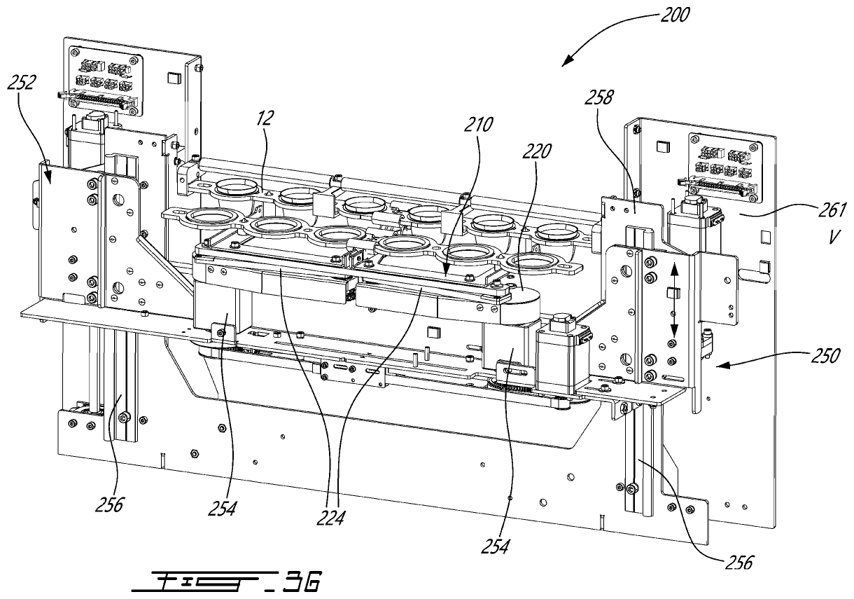

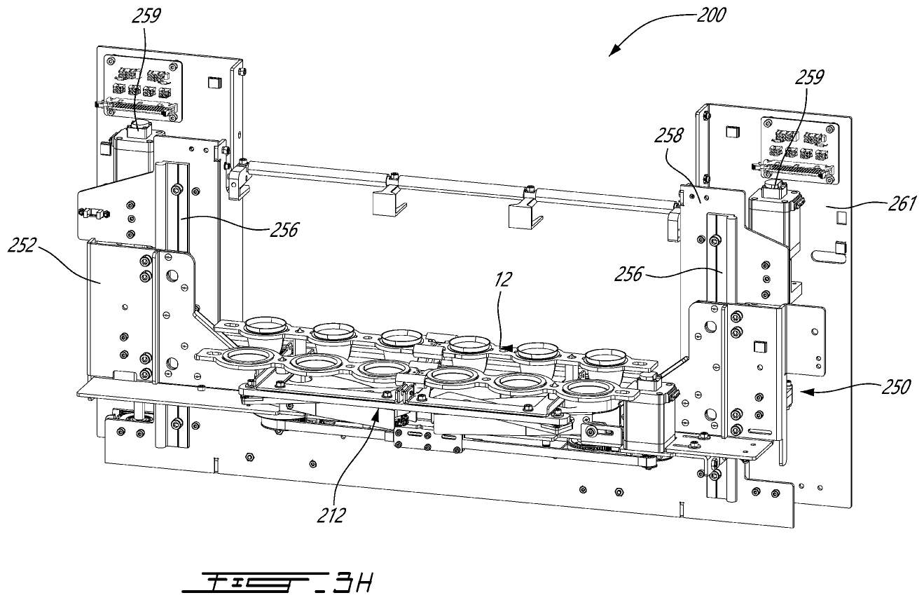

In this embodiment, the support 210 is operable to removably receive and support the sample holder 12. As shown in FIG. 3A, the support 210 can further be operable to removably receive and support a second sample holder such as a mould holder if deemed useful in a given embodiment. Different configurations of the support 210 are possible to achieve this function. For example, and referring to FIG. 3B, in one embodiment, the support 210 includes a crossbar 212C that extends between and connects a plurality of support arms 212AP, 212AC, 212AP that are transverse to the crossbar 212C and which extend outwardly therefrom, towards the fusion area. The support arms 212AP, 212AC, 212AP are spaced apart along the length of the crossbar 212C. The support arms 212AP, 212AC, 212AP include two peripheral support arms 212AP at opposite ends of the crossbar 212C, and a central support arm 212AC positioned between the peripheral support arms 212AP. Each of the peripheral support arms 212AP, 212AP bears a plurality of holder support rods 212R, and more specifically a first support rod operable to receive the sample holder 12 and a second support rod operable to receive the second sample holder. The holder support rods 212R are bodies which extend upright or vertically. The holder support rods 212R each have a terminal attachment 212T. The holder support rods 212R are spaced apart from each other.

Referring to FIG. 3B, the two holder support rods 212R do not have the same height, which is measured between the peripheral support arm 212BP and the terminal attachment 212T. A height of some of the holder support rods 212R is less than the height of other holder support rods 212R. More particularly, and referring to FIG. 3B, the holder support rods 212R include distal holder support rods 212RD which are positioned closest to a distal end of the peripheral support arm 212BP, and also include proximal holder support rods 212RP which are positioned closest to an end of the peripheral support arm 212BP nearest to the crossbar 212C. The height of the distal holder support rods 212RD is greater than the height of the proximal holder support rods 212RP. In some embodiments, such a positioning of terminal attachments 212T at different levels can correspond to a positioning of corresponding terminal attachments of support rods 117 and agitation rods 314 at different levels. In some embodiments, such a positioning of terminal attachments 212T at different levels can allow a certain amount of longitudinal overlap between corresponding sample holders and help in reducing a footprint of the fusion system for instance, or reducing the size of the heating chamber which can reduce heating costs. In some embodiments, such a positioning of terminal attachments 212T at different levels can play a role in the interaction between the handling mechanism and another mechanism such as the pouring mechanism and/or the multiple loading mechanism.

Referring to FIG. 3B, the terminal attachments 212T are conical or pointed ends of the holder support rods 212R. In the example presented in FIG. 3B, the terminal attachments are surrounded by a flat annular seat portion, and are configured the same way as the terminal attachments of the agitation rods and of the support rods, though other configurations are possible. The terminal attachments 212T of the distal holder support rods 212RD are operable to be inserted into two of the mounting apertures 12M of the tray 12T of the sample holder 12 (see FIG. 3A). The mounting apertures 12M have a diameter that is smaller than the diameter of the distal holder support rods 212RD, such that the tray 12T with the samples is able to rest on the distal holder support rods 212RD and thereby be supported by the support 210. Referring to FIG. 3B, the central support arm 212BC has a bracket 212D with bracket terminal attachments 212DT which are inserted into central mounting apertures 12MC of the tray 12T (see FIGS. 3A and 3B) so that the central support arm 12BC may also support the sample holder 12. The proximal holder support rods 212RP may be used to support other containers into which the samples may be poured, as explained in greater detail below. Other configurations of the terminal attachments 212T are possible provided that they allow for removably attaching the sample holder 12 to the support 210.

It will be noted here that the sample holders 12 (such as can be used to support containers such as crucibles, moulds or beakers for instance) can be provided with different sets of mounting apertures in order to provide for the step of engaging or disengaging the sample holder 12 from the agitation mechanism 300 using the handling mechanism 200. Indeed, a first set of mounting apertures, such as 12M for example, can be positioned at relative positions operable to engage with the distal support rods 212RD of the support 210 of the handling mechanism, and a second set of mounting apertures, such as 12MP for instance, can be positioned at relative positions operable to engage with the agitation rods 314 of the agitation mechanism 300.

Moreover, the support 210 of the handling mechanism 200 can be operable to avoid interference with the agitation rods 314 of the agitation mechanism 300. For instance, the support arms 212AP, 212AC, 212AP can be interspaced in a manner to correspond to the location of spacings between the agitation rods 314 of the agitation mechanism 300. Indeed, the support 210 of the handling mechanism 200, with the sample holder 12 received thereon, can be brought horizontally into the fusion area in a plane above the terminal ends of the agitation rods 314, and then be lowered in a manner for the terminal ends of the agitation rods 314 to pass between the prongs formed by the support arms 212AP, 212AC, 212AP of the handling mechanism 200 until the sample holder 12 becomes effectively supported by and engaged with the terminal ends of the agitation rods 314, at which point the prongs formed by the support arms 212AP, 212AC, 212AP can be horizontally withdrawn from the fusion area. Similarly, for disengaging the sample holder 12, the prongs can become horizontally engaged between the agitation rods 314 via horizontal movement, and the support 210 of the handling mechanism 200 can then be raised to disengage the sample holder 12 from the terminal ends of the agitation rods 314 (by engaging mounting apertures 12M of the support with the terminal attachments 212T of the distal holder support rods 212RD), at which point the support 210 can be horizontally withdrawn bringing the sample holder 12 with it.

In one embodiment, the handling mechanism can have a horizontal displacement mechanism 168 which is distinct from and can be operated in a coordinated manner, or independently from a vertical displacement mechanism.

Referring to FIGS. 3B to 3D, an example of a horizontal displacement mechanism 168 is presented. In this example, the horizontal displacement mechanism 168 includes a linkage 220 extending between a horizontal displacement base and the support 210 which supports the sample holder 12. As shown in FIGS. 3B to 3D, the linkage 220 is selectively extendible and collapsible, in two opposite sides relative to the horizontal displacement base, and can traverse a “neutral” position illustrated in FIG. 3C. This ability can be useful in providing convenience and flexibility of operation, and potentially in limiting the footprint of the fusion system. The two sides can be referred to as a proximal side and a distal side, referring to a point of view of an operator located in front of the fusion system for instance, with the proximal side being closer to the operator located in front of the fusion system and the distal side penetrating into the fusion area. In one embodiment, extending or collapsing the linkage 220 to or from the distal side, as shown in FIG. 3B, can be used for moving the sample holder 12 into or out from the fusion area, whereas extending or retracting the linkage 220 to or from the proximal side, as shown in FIG. 3D, can be used for moving the sample holder 12 into or out from a sample loading area from where it can more easily be accessed by an operator, for instance. Depending on the embodiment, reliability may be a significant design requirement, and a linkage 220 may block, which may be undesired. Eventual blocking in the neutral position shown in FIG. 3C can be a particular concern. It was found that the horizontal displacement mechanism 168 can be designed in a manner to alleviate such concerns, as will now be detailed.

Referring to FIG. 1C, the linkage 220 is extendible to move the support 210 (with or without the sample holder 12) longitudinally and horizontally from the neutral position in a first direction T1, into the heating chamber 110 via the opening 116 created by open door 114. The linkage 220 is also collapsible to displace the support (with or without the sample holder 12) horizontally in a second direction T2 opposite to the first direction T1, back to the neutral position. The linkage 220 is also expandable in the second direction T2 from the neutral position, which may be convenient for various reasons, such as the manual loading or unloading of the sample holder 12 from the support 210, or, if a multiple loading mechanism 400 is present in a given embodiment, engaging the multiple loading mechanism 400 for example. Different configurations of the linkage 220 are possible, and an example of one possible configuration for the linkage 220 is now described.

Referring to FIGS. 3E to 3F, the linkage 220 includes a plurality of linkage pairings 222. Two linkage pairings 222 are shown in FIGS. 3E and 3F, but more are possible. The linkage pairings 222 are spaced apart laterally from each other in a direction transverse to the first and second directions T1,T2. Each linkage pairing 222 has a driving link 224 that is pivotably connected to a driven link 226. The driving link 224 and the driven link 226 of each linkage pairing 222 pivot relative to each other. The driving link 224 is an elongated member which is actively actuated, i.e. to which motive force is applied, in order to expand and collapse the linkage 220. The driven link 226 is an elongate member which responds to an input of force and motion from the driving link 224, in order to extend and collapse the linkage 220. A distal extremity of the driven links 226 is pivotably mounted to the crossbar 212C of the support 210, such that the support 210 is positioned at a distal extremity of the linkage 220. The crossbar 212C is also a driven link in this linkage, as it constrains the location of the distal end of the driven links which can force to open the angle between driving link and the driven link when the driving link is pivoted.

For each linkage pairing 222, displacement of the driving link 224 in a first pairing of rotational directions R1/R2 causes the driven link 226 to move along T1 direction (which is in a generally horizontal orientation in the illustrated embodiment). For each linkage pairing 222, displacement of the driving link 224 in a second pairing of rotational directions R2/R1 opposite to the first pairing of rotational directions R1/R2 causes the driven link 226 to move along the T1 direction. In the neutral position, the driven link 226 vertically overlaps the driving link 224 (see FIG. 3C). The displacement of the driving links 224 of both linkage pairings 222 in the first pairing of rotational directions R1/R2 and in the second pairing of rotational directions R2/R1 can be coordinated such that the movement of both linkage pairings 222 is synchronized. Each of the linkage pairings 222 may thus be said to form an “accordion-type” mechanism (referred to below as an accordion mechanism) for extending and collapsing the linkage 220. The linkage 220 may also have other configurations. For example, in another possible configuration of the linkage 220, the linkage 220 is an assembly of telescopic members which extend and collapse relative to another to displace the sample holder 12 in the first and second directions T1,T2. An interesting feature of the accordion mechanism over a telescopic member is that an accordion mechanism may be operable to be deployable in both directions relative to its base whereas a telescopic member type may be deployable away from and back towards its base on one side of its base only.

Referring to FIGS. 3E to 3F, each driving link 224 extends between a distal end 224A that is pivotably coupled to the driven link 226, and a proximal end 224B. The proximal ends 224B remain permanently outside of the heating chamber 110, whereas the distal ends 224A may enter the heating chamber 110 when the linkage 220 is expanded into the heating chamber 110.

The base 251 of the horizontal displacement mechanism 168 can have fixed wheels 228 such as sprockets (or pulleys in an alternate embodiment), each of which is fixed relative to the base. The fixed wheels 228 can be concentric with a pivot axis of the driving link 224. Similarly, the driven links 226 each have, at their proximal end, a fixed wheel such as a sprocket 240 which does not rotate relative to the corresponding driven link, and which is concentric with the pivot axis of the driven link 226 relative to the driving link 224. A loop element 238, such as a chain or pulley, engages both sprockets 228 and 240. When the driven links 226 are pivoted, around the pivot axis intersecting their proximal end, the presence of the crossbar 212C, also acting as a driven link, forces the extension of the driven links 226, which corresponds to pivoting of the driven links 226 relative to the driving links 224, around the axis intersecting the proximal end of the driven links 226, in an orientation opposite to the orientation of pivot of the driving links. This is perceived as a rotation of the sprocket 240 from the point of view of the chain 238 which loops roughly around the length of the driving link 224, which drives the chain to circulate around its loop. However, similarly, the pivoting of the driving link 224 around the axis intersecting its proximal end is also perceived as a rotation of the sprocket 228 in the opposite direction, following the circulation of the chain 238 around its loop. The presence of at least one chain 238 associated to a corresponding driving member can help in regulating the expansion and collapse of the overall linkage and avoiding that the crossbar 212 would become obliquely misaligned, and/or can help in ensuring that the crossbar 212 does not become blocked upon displacement across the neutral position. The presence of a chain 238 and associated sprockets on each one of the two driving members can further be preferred to such end(s). In alternate embodiments, the belts and pulleys or equivalents can be used instead of chains and sprockets.

In particular, it will be noted that in the presence of a loop element such as presented above, pivoting of the driving link around its proximal end can lead to a controlled extension or retraction of the distal end of the driven link in the T1 or T2 direction independently of the influence of the crossbar 212C. Indeed, in the absence of a loop element and of the crossbar 212C, pivoting the driving link may not lead to pivoting of the driven link relative the driving link. The presence of the loop element and wheels can control the pivoting of the driven link relative the driving link independently of the crossbar 212C, and in a potentially more reliable manner, especially if two loop elements are used on both linkage pairings and for movement across the neutral position, as this can help in avoiding un-symmetric mismatch between the linkage pairings.

Referring back to FIG. 3F, the pivoting of the driving links in opposite rotational directions R1,R2 can lead to pivoting of the driven links 226 in corresponding opposite rotational directions. There is no relative rotation between each of the fixed wheels 228 and the fixed referential of the horizontal movement base 251, such that rotation of the driving link 224 directly causes rotation of the driven links 226 in the opposite rotational directions R1,R2 and the subsequent extension or collapse of the driven links 226 to displace the linkage 220. The fixed wheels 228 and the horizontal movement base 251 can be positioned permanently outside of the heating chamber 110.

The driving link 224 may be driven to pivot in any suitable manner. For example, and referring to FIG. 3E showing an underside of the handling mechanism 200, a motor output 230 of an electric motor 263 of the handling mechanism 200 can output a rotational drive to a drive belt 232. The drive belt 232 is mounted about two belt wheels 234 and a tensioner wheel 236. Each of the belt wheels 234 is collocated with one of the fixed wheels 228, such that the belt wheels 234 and driving links 224 rotate together about the same axis, and such that rotation of the belt wheel 234 causes rotation of the drive link 224. The motor output 230 imparts a rotational drive to the drive belt 232, which in turn causes the belt wheels 234 and thus the drive links 224 to rotate in the rotational directions R1,R2.

The drive wheels 228 can help to synchronise the movement of the linkage pairings 222. Referring to FIG. 3E1 and 3F, each of the fixed wheels 228 is in the form of a sprocket which is meshed with a drive chain 238. Each drive chain 238 is also meshed with a driven sprocket 240 at the distal end 224A of each driving link 224. Each driven sprocket 240 is mounted to, and in fixed rotational relationship with, one of the driven links 226 so that rotation of the driven sprockets 240 causes rotation of the driven links 226 relative to the driving links 224. It will thus be appreciated that rotation of the belt wheels 234 in the rotational directions R1,R2, with the drive wheels 228 remaining fixed relative to the base 251, will cause cycling of the drive chains 238 and a rotation of the driven sprockets 240, thereby causing the driven links 226 to extend away from, or collapse toward, the driving links 224, depending on the rotational direction of the motor. In this embodiment, the sprockets have a ratio of 1:2 but other ratios may be preferred in other embodiments. Referring to FIG. 3F, each of the driving links 224 has a chain tensioner 242 whose position may be fixed along an elongated slot 244 that extends through each driving link 224 and along some of its length. Displacement of the chain tensioner 242 along the slot 244 allows for varying the tension of the drive chain 238.

The movement of the linkage 220 in the first and second directions T1,T2 may be better appreciated with reference to FIGS. 3B to 3D. Referring to FIG. 3C, the linkage 220 is shown in a neutral position, in which the driven links 226 are collapsed toward the driving links 224 and vertically overlap the driving links 224. From the collapsed position shown in FIG. 3C, the linkage pairings 222 may expand in the first pairing of rotational directions R1/R2 in order to displace and expand the linkage 220 in the first direction T1 so as to displace the support 210 and the supported sample holder 12 as shown in FIG. 3B (e.g. to displace the support 210 and the supported sample holder 12 into a heating chamber). From the neutral position shown in FIG. 3C, the linkage pairings 222 may alternatively expand in the second pairing of rotational directions R2/R1 in order to displace and expand the linkage 220 away from the heating chamber 110 in the second direction T2 so as to displace the sample holder 12 toward a multiple loading mechanism as shown in FIG. 3D (e.g. to displace the support 210 and sample holder 12 away from a heating chamber into a multiple loading mechanism).

Referring to FIGS. 3A, 3H and 3G, an example of an upright (e.g. vertical) displacement mechanism 250 is presented in greater detail. The upright displacement mechanism 250 allows for adjusting the vertical position of the support 210, which, in this specific embodiment, is achieved via a vertical movement of the horizontal displacement mechanism 168, and more particularly of the support 210, thereby permitting adjustment of the vertical position of the sample holder 12 in potentially different phases of the fusion cycle. The upright displacement mechanism 250 is connected to the base 251 of the linkage 220 (as shown in FIG. 3F) so as to vertically displace the linkage 220. The upright displacement mechanism 250 may take any configuration to achieve the functionality ascribed to it herein.

For example, and referring specifically to the embodiments shown in FIGS. 3G and 3H, the upright displacement mechanism 250 has at least one truck 252 or other slidable carrier that is mounted, via supports 254 of the truck 252, to the driving links 224 of the linkage 220. The upright displacement mechanism 250 has at least one rail 256 or other sliding guide which has a vertical orientation and which is mounted to, or provided on, a fixed or immobile mounting bracket 258 of the upright displacement mechanism 250. Two rails 256 are present on the mounting bracket 258 and spaced laterally apart in FIGS. 3H and 3G, but more or fewer rails 256 are possible. The mounting bracket 258 is mounted to, or part of, a structural or immobile component of the fusion system 10 (e.g. external walls of the furnace 100). The upright displacement mechanism 250 has two electrical motors 259 and associated endless screw mechanisms mounted to laterally opposite sides of an upright displacement base 261. In order to displace the linkage 220 in a vertical direction V and therefore also displace the sample holder 12, the motor 259 actuates a component such as an endless screw or wheel to cause the truck 252 to slide vertically along the rails 256, thereby displacing the truck 252 relative to the mounting bracket 258. Vertical adjustment of the truck 252 causes a corresponding vertical movement of the linkage 220, and thus allows for vertically adjusting the sample holder 12 supported by the linkage 220. In at least one embodiment, the handling mechanism 200 allows for an up-down movement of the sample holder 12 (i.e. with the upright displacement mechanism 250), in addition to a forward-rear movement of the sample holder 12 provided by the linkage 220.

As disclosed above, the agitation mechanism 300 can agitate the sample holder 12, and thus the samples, while they are being fused. The agitation mechanism 300 can rotate the agitation rods 314 by rotating the rod support 311 about the agitation axes 312. In an embodiment, and referring to FIGS. 4A to 4D, the agitation rods 314 can be revolved about the virtual axes 316′ and are laterally offset from the virtual axes 316′. For example, and referring to FIGS. 4C and 4D, the agitation axes 312 are formed at the locations shown, and the agitation rods 314 and their attachments 318 are spaced laterally apart from the agitation axes 312 in the first translation direction D1. For example, and referring to FIG. 4C, the agitation axes 312 are formed at the locations shown, the agitation rods 314 and their rod axes 316 are parallel to the agitation axes 312, but are spaced laterally apart, or offset, from the agitation axes 312 in the first translation direction D1. For example, and referring to FIG. 1D, the agitation rods 314 extend upwardly from the base 310 through openings 115 in the lower or bottom heating chamber wall, and the agitation rods 314 and their rod axes 316 rotate within the openings 115 about the agitation axis 312. The openings 115 can be cylindrical. The rotation of the base 310 and of the agitation rods 314 which support the sample holder 12 agitate the sample holder 12 within the heating chamber 110 while the heating element(s) 120 heat the heating chamber 110. The rotational motion of the base 310 and of the agitation rods 314 may be reciprocating or eccentric. Furthermore, although described herein as a “rod”, each agitation rod 314 may be any other non-cylindrical elongated member which revolves around an axis to agitate and support the sample holder 12.

The rotation of the rod support 311 and of the agitation rods 314 about the agitation axis 312 may be achieved using any suitable mechanism. An example of such a rotational mechanism 320 is now described with reference to FIGS. 4B, 4C and 4D. The rotational mechanism 320 and its components are positioned outside of the heating chamber 110. The rotational mechanism 320 includes a motor output 322 of an electric motor, which outputs a rotational drive to a drive belt 324. The drive belt 324 is mounted about two belt wheels 326. The rotational mechanism 320 has rotation arms 328 each of which extends between a lower end fixedly mounted to one of the belt wheels 326 and an upper end fixedly mounted to the base 310 via bearings 321. Each of the belt wheels 326 is collocated with a rotation arm 328, such that the belt wheels 326 rotate the rotation arms 328 about the agitation axes 312, and such that rotation of the belt wheels 326 causes rotation of the base 310 and the rotation rods 314 about the agitation axes 312. Referring to FIG. 4D, each of the rotation arms 328 has a lower portion 328L fixedly mounted to one of the belt wheels 326 for rotation therewith, an upper portion 328U fixedly mounted to the base 310 for rotation therewith, and a middle portion 328M extending laterally between and interconnecting the lower and upper portions 328L,328U. The middle portion 328M laterally (horizontally) offsets the lower and upper portions 328L, 328U. The effect of the laterally-extending middle portion 328M is that rotation of the belt wheel 326 will cause the lower portion 328L to rotate about a rotation arm axis 328A, and will cause the laterally-offset upper portion 328U to rotate about the same rotation arm axis 328A. Each rotation arm axis 328A is collinear with one of the agitation axes 312. The motor output 322 imparts a rotational drive to the drive belt 324, which in turn causes the belt wheels 326 and thus the rotation arms 328 to rotate about the rotation arm axis 328A to thereby impart a rotational drive to the base 310 and to the agitation rods 314 so that they rotate about the agitation axis 312. The belt wheels 326 help to synchronise the movement of the base 310 and the agitation rods 314.

It will be noted that in a configuration such as shown in FIG. 4C, the agitation rods 314 can be significantly longer than wide. Similarly, as perhaps best seen in FIG. 1D, the support rods 117 may also be significantly longer (taller) than wide. This may lead to challenges in dimensional tolerance at the free tips (i.e. terminal ends) of the agitation rods 314 and/or support rods 117, where the terminal attachments configured for supporting the sample holder can be located. Variability in the exact position of the terminal attachments from one fusion system to another can cause some mismatches, in some cases, between the relative position of the terminal attachments and the relative position of the sockets formed in the second face of the body of the sample holders which are configured to receive the terminal ends at the free tips. One way to address such a source of mismatch would be to increase a size of the sockets and to increase the diameter of the rods, but such a solution may not be suitable in all embodiments. In the embodiment presented in FIGS. 2A and 2B, it will be recalled that the peripheral sockets 12MP, were made obround in this embodiment, which may provide some degree of adaptability to situations where the corresponding terminal attachments are slightly too far away or too close to one another. However, the terminal attachments may have other types of misalignments.

For instance, referring to FIG. 2C, a situation where the free tip of a right-hand side rod is misaligned transversally to the axis of alignment 610 of the rod ends 612 (e.g. terminal attachments) is presented. As schematized in FIG. 2D, this can lead to a situation where three of the rod ends may engage suitably into corresponding sockets 614 of the sample holder 616, but where the right-hand terminal end may then be rearwardly offset from the remaining socket. In such a scenario, the misalignment between the right-hand side terminal end and the right-hand side socket may prevent the sample holder 616 from sitting squarely against the corresponding features, such as flat annular seats surrounding the conical portions of the terminal attachments, and may lead to instability, especially in the case of the terminal attachments of the agitation rods which may revolve during fusion. To this end, it may be preferable for the body of the sample holder 616′ to be made of two or more segments 618, 620. The segments 618, 620 can be disposed adjacent one another along the length of the body (which coincides here with the axis of alignment 610). The segments 618, 620 can be loosely connected to one another in a manner allowing some degree of relative displacement between the two segments 618, 620, such as may be useful to accommodate the variations in relative position of the tips of the rods which can occur due to dimensional tolerances and tolerance stacking in the assembly, while preventing the segments 618, 620 from being entirely separated from one another. In the embodiment presented in FIG. 2A, for instance, the sample holder includes two sample holder segments, each one having a plurality of sockets 12M and a plurality of container receptors 12A, and both being somewhat loosely connected to one another by connectors. FIG. 2F presents an alternate embodiment which is quite similar to the embodiment of FIGS. 2A and 2B, and where the connectors 622 are shown exploded. The connectors 622 can serve to limit the amount of relative movement between the segments 624, 626 in the plane associated to the body of the sample holder. For instance, the two (or more) segments 624, 626 may be allowed to pivot slightly relative one another, via the connectors 622, around a vertical axis, to offset slightly from one another transversally to the length of the sample holder, or be slightly spaced apart or brought closer towards one another within the plane. The connectors 622 may also allow some degree of pivoting away from the plane coinciding with the other segment, e.g. pivoting around a horizontal forward/rearward axis, or torsion, e.g. pivoting around a lengthwisely oriented axis. In the illustrated embodiment, the connectors 622 are somewhat cylindrical members with notches defined longitudinally at opposed ends, and configured to receive connexion prongs 629 from the first segment 624, and the second segment 626, at opposite ends thereof.

Returning to the example situation presented in FIGS. 2C to 2E, one can see how such degree of freedom between segments 618, 620 of the sample holder 616 may be beneficial. In the situation presented in FIG. 2E, the degree of freedom allows the right-hand side segment 620 to pivot slightly around a vertical axis to allow aligning the right-hand side socket with the right-hand side agitation rod terminal attachment, and may allow the sample holder 616 to sit squarely against the terminal attachments, such as onto the annular seats surrounding the conical portions in the example embodiment presented above, where a sample holder made of a single integral component such as shown in FIG. 2D would instead have jammed against the misaligned rod tip and sat somewhat obliquely and unstably.

It will be noted that the construction of the sample holder may need to be able to sustain high temperatures which may occur in a heating area. In the embodiment presented in FIG. 2F, the segments 624, 626 of the body of the sample holder may be made of silicon nitride for instance, which is a material which is resistant to high temperatures. The agitation rods, on the other hand, may be made of a different material, such as alumina for instance. In some situations, there may be a physical/chemical mismatch between the materials used in the sample holder and in the terminal ends of the agitation rods or support rods, which may lead to adherence between the two during contact at high temperature in the heating chamber, which may be undesired. In some embodiments, such inconveniences may be addressed by using inserts 628 in the body of the sample holder to provide the sockets 630 configured to receive the terminal ends. The inserts 628 may be made of the same material as the one they are configured to engage, or a material otherwise known to be compatible (i.e. compatible in that they do not adhere to one another during the fusion/heating cycles in the heating chamber). In this specific embodiment, the inserts 628 can be made of alumina for instance. In the embodiment of FIG. 2F, such inserts 628 are used, as shown exploded. FIG. 2H presents a view of the embodiment of FIG. 2F with the inserts engaged, from the first side, with a section across one of the inserts 628 to show details of the assembly. FIG. 2G presents a view of another embodiment having similar inserts and insert apertures to the ones shown in FIGS. 2H and 2F, and where the inserts 628 are shown in a position of use, seen from the second side of the sample holder. The inserts 628 may be locked into position by use of clips 634. In the illustrated embodiment, clips 634 in the form of platinum wire are used. For the purpose of providing a fully detailed description, it will be noted here that in the embodiments presented in FIGS. 2F-2H, the connectors 622 may also be made of alumina or other suitable material. A wire, such as a platinum wire, may further be used to loosely tie adjacent segments to one another (not shown), to prevent the segments 624, 626 from becoming spaced apart from one another past a certain extent (e.g. from becoming disengaged from the connectors 622).

In the embodiment shown in FIG. 2F, it will be noted that the apertures 638 defined across the thickness of the body and forming the container receptors are generally circular in the plane of the body, but have one or more radially-protruding indentations 640. In the embodiment shown in FIG. 2F, the one or more radially-protruding indentations 640 can be used in combination with a collaborating radially-protruding feature on the container received in the corresponding aperture. Indeed, the radially-protruding feature of the container (not shown) can be engaged with the radially-protruding indentation, and may be used as mating positioning features to prevent the container from rotating in the container receptor during use of the system, e.g. during agitation.

FIG. 2G presents yet another embodiment, still similar to the embodiment shown in FIG. 2F, but where a greater number of radially-protruding indentations 642 are provided in the container receptors, to the point of giving the aperture forming the container receptor a circularly crenelated appearance. In this embodiment, the radially-protruding indentations are also broader circumferentially than the indentations 640 included in the embodiment presented in FIG. 2F, and can serve for increasing cooling speed, e.g. as circulation apertures for cooling air.

In some embodiments, cooling of the sample down to solidify the sample into a solid analytical sample can be actively assisted in a manner to further reduce process duration. in one embodiment, the fusion system 10 can be provided with a dedicated, actively ventilated, cooling station. In the illustrated embodiment, as perhaps best seen in FIG. 2A, a cooling station 170 can be provided outside the heating chamber 110, below the generally horizontal (potentially oblique) ingress and egress path taken by the handling mechanism as it carries the samples into or out from the heating chamber. The handling mechanism 200 can be provided with movement capabilities in more than one orientation. For instance, the handling mechanism 200 can be provided with horizontal movement capabilities for movement in the orientation of the ingress and egress path, and with vertical movement capabilities for movement between the cooling station 170 and the ingress and egress path. Various alternatives exist for providing such capabilities, an example of which will be provided in further detail below. The cooling station 170, in this embodiment, can include one or more ventilators 171 and one or more ducts 172 which can be operable to draw fresh, cool air from outside an outer housing of the fusion system 10 and conveying it and directing it onto the crucibles or moulds holding the samples in a manner to favor heat transfer from the samples and equipment into the flow of air and accelerate the cooling of the samples. It will be understood that in alternate embodiments, a dedicated cooling station may be omitted or located elsewhere, and a handling mechanism can be provided with only horizontal movement capabilities for instance.

In one embodiment, the one or more ventilators (when present) may be controlled by the controller 20 in a fully or partially automated manner. Depending on the embodiment, the ventilator control process can be based on feedback from one or more sensors associated to the handling mechanism 200 or to the cooling station, to name some examples. In some embodiments, the controller 20 can have a function to trigger an alarm based on an indication received from a such a sensor associated to the cooling operation, which can be based on conditions defined in a set of instructions stored in the non-transitory memory of the controller for instance. Such an alarm can be in the form of a visual or audible indicator, e.g. trigger the activation of a graphical user interface element on the display screen, or trigger a given level of alarm on a light tower indicator 22, such as yellow light alarm for instance.

The fusion system 10 disclosed herein may help improve the robustness, reliability, productivity, quality of results, and/or ease of use of the fusion process. In so doing, the fusion system 10 may reduce the need for technician time or labour and thus contribute to reducing staffing costs associated with the fusion process. One or more mechanism(s) as presented herein, or it(s) control scheme, can lead to reducing overall cycle time or otherwise increase productivity of a given fusion system. The potential robustness of the fusion system 10 may help to lower down or idle time of the machine and thus lower cost of operations to maximize profits and margins in the contract analysis business. The use of the powered and mechanized handling mechanism 200 may allow for automatic and/or autonomous/semi-autonomous fusion cycles. This may improve laboratory workflow which is often a common bottleneck in fusion cycles which can result in long cycle times. In at least one embodiment, the fusion system 10 includes a 6-position resistive-heating furnace wherein 6 positions in the furnace can undergo corresponding fusion process steps simultaneously.

Depending on the embodiment, one or more detection means can be provided to automatically validate the position of, or the presence or absence of, a given element of the system or sample. The detection means can be selected as a function of the specific embodiment based on the knowledge of persons having ordinary skill in the art and can, for example, include one or more of a proximity sensor, a camera, a video camera, a weight sensor, or any other suitable type of sensor. For example, a sensor can be used to determine the presence or absence of containers in the sample support (e.g. confirming that any required moulds are indeed present prior to commencing the fusion process), confirming the presence or absence of a sample inside containers, confirming that the handling mechanism has been withdrawn from the fusion area prior to closing the door, confirming that the handling mechanism is aligned with the agitation mechanism prior to lowering, etc. Via a user interface, partially automated confirmation procedures involving user response may also be implemented. For instance, the controller may prompt, at the user interface, the user to confirm that an element of the system or samples are at a given position, present, or absent, at any suitable point of the fusion process, and proceed to the next step of the fusion process contingent upon receiving, from the user interface, the requested confirmation from the operator.

The embodiments described in this document provide non-limiting examples of possible implementations of the present technology. Upon review of the present disclosure, a person of ordinary skill in the art will recognize that changes may be made to the embodiments described herein without departing from the scope of the present technology. For example, although the handling mechanism 200, the agitation mechanism 300, the multiple loading mechanism 400 and the pouring mechanism 500 are described separately to ease comprehension, it will be appreciated that the fusion system 10 in embodiments includes one of these, or more than one of these in any combination. Yet further modifications could be implemented by a person of ordinary skill in the art in view of the present disclosure, which modifications would be within the scope of the present technology.

1. A method of fusing samples in a furnace, the method comprising:
terminal ends of upwardly extending agitation rods supporting a sample holder containing the samples at a fusion area of the furnace;
fusing the samples at the fusion area;
agitating the sample holder and the samples at the fusion area, including revolving the terminal ends around corresponding upwardly oriented axes.

2. The method of claim 1 comprising supporting the agitation rods collectively at a common rod support, and said revolving the terminal ends includes moving the common rod support in a circular or ellipsoid path.

3. The method of claim 1 further comprising engaging the sample holder with the terminal ends prior to said fusing and agitating, and disengaging said sample holder from said terminal ends subsequently to said fusing and agitating.

4. The method of claim 3 wherein said engaging includes lowering the sample holder onto the terminal ends and said disengaging includes raising the sample holder from the terminal ends.

5. The method of claim 4 wherein said lowering and said raising is performed by lowering and raising a support having a plurality of parallel, horizontally oriented prongs, while the prongs are interspersed with the agitation rods.

6. The method of claim 5 further comprising said revolving includes positioning the agitation rods in the interspersed configuration with the prongs prior to said engaging and disengaging.

7. The method of claim 1 wherein said revolving the terminal ends includes moving the terminal ends along associated arcuate paths in a first angular orientation.

8. The method of claim 7 wherein said revolving includes, subsequently to said moving the terminal ends along the associated arcuate paths in the first angular orientation, moving the terminal ends along the associated arcuate paths in a second angular orientation.

9. The method of claim 1 wherein said revolving the terminal ends includes moving the terminal ends along a plurality of revolutions around the corresponding upwardly oriented axes.

10. A fusion system comprising:
a furnace having a fusion area, and at least one heating element; and
an agitation mechanism having a set of agitation rods, each agitation rod extending upwardly to a terminal end located at the fusion area, the terminal ends operable to support a sample holder, the agitation mechanism being operable to revolve the terminal ends around parallel, upwardly oriented rotation axes, while the at least one heating element is activated.

11. The fusion system of claim 10 wherein the agitation mechanism has at least one rotary shaft positioned below the agitation rods, the at least one rotary shaft being rotatable by an actuator, the agitation rods each having a proximal end connected to the at least one rotary shaft, wherein the rotation of the at least one rotary shaft is communicated by the connection and by the agitation rod to cause the revolving of the terminal ends.

12. The fusion system of claim 11 wherein the furnace has a heating chamber enclosing the fusion area, wherein the at least one rotary shaft, the connection, and the proximal ends of the agitation rods are positioned outside the heating chamber, the agitation rods extending into the heating chamber via corresponding apertures formed in a bottom wall of the heating chamber.

13. The fusion system of claim 12 wherein the proximal ends of the agitation rods are secured to a common rod support, the rod support connecting the agitation rods to the at least one rotary shaft.

14. The fusion system of claim 13 wherein the rod support has a planar member covering the apertures formed in the bottom wall.

15. The fusion system of claim 11 comprising at least two of said at least one rotary shaft, the at least two rotary shafts being offset from one another, all rotary shafts connecting the common rod support in an eccentric manner.

16. The fusion system of claim 15 wherein the first rotary shaft and the second rotary shaft have corresponding drive wheels, further comprising a loop member driven by the actuator to drive the drive wheels.

17. The fusion system of claim 10 further comprising a controller operable to control the agitation mechanism.

18. The fusion system of claim 10 wherein the sample holder has sockets mating with the terminal ends, the sample holder being disengageable from the agitation rods by raising the sockets away from the terminal ends.
